(19) United States
(12) Patent Application Publication
(10) Pub. No.: US 2006/0236241 A1
(43) Pub. Date: Oct. 19, 2006

(54) Usability evaluation support method and system

(76) Inventors: Etsuko Harada, Yokohama (JP); Takafumi Kawasaki, Machida (JP); Hitoshi Yamadera, Kokubunji (JP); Yuuki Hara, Tokyo (JP); Ryota Mibe, Sagamihara (JP); Nozomi Uchinomiya, Yokohama (JP); Yoshinobu Uchida, Yokohama (JP); Yasuhito Yamaoka, Yokohama (JP); Keiji Minamitani, Kawasaki (JP); Katsumi Kawai, Yokohama (JP); Jun Shino, Kawasaki (JP); Takahiro Inada, Musashino (JP); Chiaki Hirai, Tokyo (JP); Kaori Kashimura, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/545,323

(22) PCT Filed: Feb. 6, 2004
(86) PCT No.: PCT/JP04/01304

§ 371 Date: Jan. 5, 2006

(30) Foreign Application Priority Data
Feb. 12, 2003 (JP) 2003-33956

(51) Int. Cl. G06F 3/00

(52) U.S. Cl. 715/700

(57) ABSTRACT

The objective of this application is to make it possible to timely acquire the user's evaluation about evaluation-targeted content. A survey window is provided to include a title region, an operation region and a content region. The content region indicates the evaluation-targeted content that the evaluator evaluates. The operation region indicates photographs of agent's faces as help buttons, and feeling input buttons that the evaluator selectively operates according to the emotion experienced when estimating the evaluation-targeted content. The evaluator selectively operates the feeling input buttons when the evaluator experiences an emotion while browsing the evaluation-targeted content to estimate. Thus, the evaluation about the evaluation-targeted content can be more accurately obtained.

### TECHNICAL FIELD

The present invention relates to a usability evaluation support method and system that provide support to help the users evaluate Web sites about whether they are easy to use.

### BACKGROUND ART

As the Web sites for users, there are ones so easy to use and adequate for the user, or others taking much time to access and difficult to understand their contents. These hard-to-use Web sites must be improved; otherwise, they will be refused by the user.

The general method for improving Web sites is to display information (content) transmitted from the Web sites so that the user can be requested to browse it and that the evaluation results can be gathered make a questionnaire survey.

As an example of the method, there is known a technique (for example, see JP-A-10-327189). In this example, information is supplied from an information providing function according to the demand from a client and displayed on the client terminal. Then, the user browses this information and enters the evaluation about this information after the browsing or grades about this information are determined from the operation history of the user. Thereafter, the evaluation is transmitted to an evaluation registering function.

There is another technique (for example, see JP-A-2001-51973). In this example, one system is formed of a Web server, a delivery server, a questionnaire server and a user terminal so that the user can evaluate the supplied content. The evaluation (questionnaire) that the user makes about the content can be acquired as follows.

That is, when the user evaluates content, the user terminal requests the Web server to send the content in order for the user to estimate the content. The Web server transmits a list of content to the user terminal so that the list of content can be displayed on the terminal. The user selects a desired content from the list, and requests the questionnaire server to send this selected content. The questionnaire server transmits the address of the requested content and the questions of the questionnaire to the user terminal so that this information can be displayed on the terminal. Thus, the user requests the delivery server to send the content according to this address. The delivery server delivers the content to the user terminal. Therefore, the user terminal has this content and the questionnaire displayed. The user can browse the content and answer the questionnaire. When the user transmits data of the answer to the questionnaire, the answer data is sent to the questionnaire server, where the answer data is received and stored.

Moreover, there is another usability evaluation support system in which the states of a system are recorded as a history and reproduced to use in the evaluation about the usability of the system as disclosed in JP-A-2001-51876. There is known another user/interface evaluation support system and user/interface evaluation support method (see JP-A-8-161197). In this method, the processes of operation on the user/interface displayed on the screen are stored, and the troublesome operation in the user/interface is judged according to the recorded operation processes or the degree of association between the buttons on the user/interface is estimated according to the processes. The results are displayed on the screen.

Furthermore, there is another prior art as described in the document of Web Complaint Desk: A system for extracting user's potential needs (HCI International 2003 Adjunct Proceedings, pp. 293-294, 2003). In this example, an evaluation tool is incorporated within a proxy server so that the user's complaint, opinion and demand can be taken in through the Internet without changing the evaluation-targeted sites when the user is successively experiencing and browsing pages and sites on the Web.

### DISCLOSURE OF INVENTION

Incidentally, as described in the above JP-A-10-327189, when information for browse is evaluated, a performance grade of, for example, 50 points, or 50% of the perfect is used. In addition, a grade is given to each browsing operation such as printing-out of page and downloading of file, and the total grade is transmitted to a server. In this case, the overall evaluation can be carried out after the browsing, and the information for browse can be determined to be good or bad according to the overall evaluation. However, individual parts of the information for browse cannot be evaluated correctly. The user has various feelings according to the content of the information while browsing the information, and such feelings are important for the evaluation of each part of the information. The user's emotion experienced about the information while the user is browsing it can be rather considered as correct evaluation about this information. The above patent document, JP-A-10-327189 describes that such feelings are integrated and issued after the browse.

The above JP-A-2001-51973 also describes that the user answers to the questionnaire after browsing the content, and the answer is based on the total evaluation after the browse. In addition, since the questionnaire takes a query form using questions, the user sometimes cannot issue correct evaluation of content as the answer to the questionnaire depending on the content of questions.

In the methods disclosed in the JP-A-2001-51876 and JP-A-8-161197, only the history of user's arbitrary operations is analyzed, and the user's subjective evaluation cannot be obtained about the evaluation-targeted system by any method. When the usability is evaluated, it is important for the user to judge whether the system is easy to use. The conventional methods do not have this method of acquiring this decision, but analyzes only the operation history. Therefore, it is necessary to evaluate the usability more exactly.

In addition, in the method described in the document of HCI International 2003 Adjunct Proceedings, pp. 293-294, 2003, the user's complaint, opinion and demand are acquired on the proxy server while the user is successively experiencing and browsing pages and sites on the Web. Recently, the content transiting on the client side such as dynamic content has been frequently used on Web site. Therefore, in the usability evaluation support for sites, only the data acquirable on the server side is not enough to grasp the operations the user makes. Thus, besides the method described in the document of HCI International 2003 Adjunct Proceedings, pp. 293-294, 2003, another method for a usability evaluation is required.

Accordingly, it is an objective of the invention to provide a usability evaluation support method and system capable of timely acquiring the user's evaluation about the browse-targeted content with the above problems solved.

The above objective and other objectives of the invention and novel features of the invention will be understood from the following detailed description and the accompanying drawings.

The summary and effect of the typical ones of the inventions disclosed in this application will be briefly described as follow.

The present invention is a usability evaluation support method that causes the evaluator terminal to display evaluation-targeted content of evaluation-targeted sites so that the user can evaluate the content. In this method, a survey window containing the evaluation-targeted content and a plurality of feeling input buttons is displayed on the evaluator terminal so that the evaluator can selectively operate the feeling input buttons while estimating the evaluation-targeted content, thus the user's emotion information being timely entered on the window during the evaluation of the content. Therefore, the user's feeling to the content can be acquired while the user is browsing the content for evaluation, and thus the user's evaluation about the content can be more accurately obtained.

### BRIEF DESCRIPTION OF THE DRAWINGS

FIG. 1 is a block diagram showing the construction of an embodiment of a usability evaluation support method and system according to the invention.

FIG. 2 is a flowchart of a specific example of the operation for the content evaluation in the proxy server shown in FIG. 1.

FIG. 3 is a flowchart of the operation procedure and associated window display on the evaluator terminal to support the evaluation in the embodiment shown in FIG. 1.

FIG. 4 shows a specific example of the questionnaire implementation confirmation dialog box displayed in step 200 of the flowchart shown in FIG. 3.

FIG. 5 shows a specific example of the agent selection dialog box displayed in step 201 of the flowchart shown in FIG. 3.

FIG. 6 shows a specific example of the agent-greeting window displayed in step 202 of the flowchart shown in FIG. 3.

FIG. 7 shows a specific example of the operation guide window displayed in step 203 of the flowchart shown in FIG. 3.

FIG. 8 shows a specific example of the profile questionnaire dialog box displayed in step 204 of the flowchart shown in FIG. 3.

FIG. 9 shows a specific example of the post-questionnaire window displayed in step 205 of the flowchart shown in FIG. 3.

FIG. 10 shows a specific example of the survey window displayed in step 206 of the flowchart shown in FIG. 3.

FIG. 11 shows a specific example of the non-operation time question dialog box displayed in step 208 of the flowchart shown in FIG. 3.

FIG. 12 shows a specific example of the “RETURN” depression dialog box displayed in step 210 of the flowchart shown in FIG. 3.

FIG. 13 shows a specific example of the revisit dialog box displayed in step 212 of the flowchart shown in FIG. 3.

FIG. 14 shows a specific example of the time-out window displayed in step 214 of the flowchart shown in FIG. 3.

FIG. 15 shows a specific example of the “IRRITATED” depression dialog box displayed in step 216 of the flowchart shown in FIG. 3.

FIG. 16 shows a specific example of the “AT A LOSS” depression dialog box displayed in step 217 of the flowchart shown in FIG. 3.

FIG. 17 shows a specific example of the “ENJOYING!” depression dialog box displayed in step 218 of the flowchart shown in FIG. 3.

FIG. 18 shows a specific example of the “WONDERFUL!” depression dialog box displayed in step 219 of the flowchart shown in FIG. 3.

FIG. 19 shows a specific example of the “WANT TO SAY ONE WORD” depression dialog box displayed in step 220 of the flowchart shown in FIG. 3.

FIG. 20 shows a specific example of the agent's face photograph depression dialog box displayed in step 221 of the flowchart shown in FIG. 3.

FIG. 21 shows a specific example of the “WORK END” depression dialog box displayed in step 223 of the flowchart shown in FIG. 3.

FIG. 22 shows a specific example of the additional questionnaire dialog box displayed in step 224 of the flowchart shown in FIG. 3.

FIG. 23 shows a specific example of the end-greeting window displayed in step 225 of the flowchart shown in FIG. 3.

FIG. 24 shows an example of the list of the evaluation result stored in the evaluation content management DB of the proxy server shown in FIG. 1.

FIG. 25 schematically shows a specific example of statistic data involved in the evaluation result produced by the proxy server shown in FIG. 1.

FIG. 26 is a block diagram of the information processor that has incorporated therein an evaluation plug-in program for usability evaluation that will be described in the section of embodiment 2.

FIG. 27 is a block diagram of the hardware structure of the information processor that has information input means and information display means as described below in the section of embodiment 2 and that can be connected to a network.

FIG. 28 is a diagram showing a network structure used when a method of embodiment 2 is implemented.

FIG. 29 is a diagram showing the algorithm of evaluation event processor 2104.

FIG. 30 is a diagram showing the algorithm of operation event acquisition unit 2106.

FIG. 31 is a diagram showing the algorithm of content event acquisition unit 2107.

FIG. 32 shows an example of the format of evaluation log table 700.

FIG. 33 shows an example of the format of operation log table 800.

FIG. 34 shows an example of the format of content log table 900.

FIG. 35 shows an example of the evaluation interface displayed for the user to enter evaluation information.

FIG. 36 shows an example of the free-writing field 1003 of FIG. 35 that is displayed within another window 1101.

FIG. 37 shows an example of the evaluation result that can be produced from the information of evaluation log table 700.

FIG. 38 is a diagram showing the algorithm of data transmitter 2107.

FIG. 39 shows an example of the aggregate result table.

FIG. 40 shows an example of the evaluation result displayed using the information of aggregate result table 1400.

FIG. 41 is a diagram of the window displayed to show the evaluation result with the user's evaluation grouped for each URL.

FIG. 42 is a diagram showing an example of the comment list of the user who evaluated the window of the URL of hogel.html as “IRRITATED” as illustrated in FIG. 41.

FIG. 43 is a diagram showing an example of the evaluation interface that enables the user to specify the location of the evaluation within the displayed information.

FIG. 44 shows an example of the structure of plug-in DB 2108.

FIG. 45 is a block diagram showing the construction of the conventional information processor.

### BEST MODE FOR CARRYING OUT THE INVENTION

### Embodiment 1

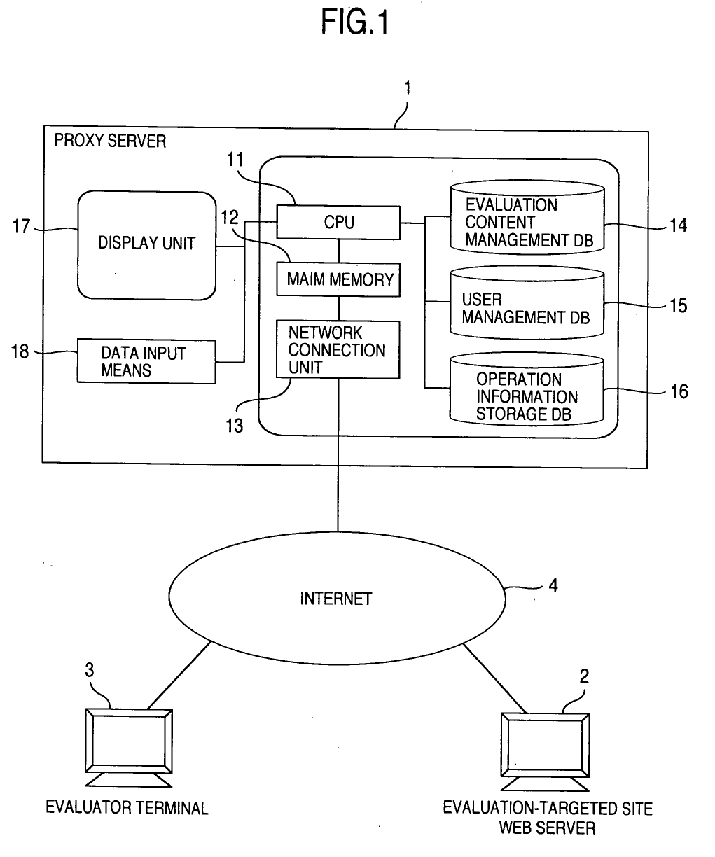

FIG. 1 is a block diagram showing an embodiment of the usability evaluation support method and system according to the invention. Referring to FIG. 1, there are shown a proxy server 1, a CPU (Central Processing Unit) 11, a main memory 12, a network connection unit 13, an evaluation content management DB (database) 14, and a user management DB 15. In addition, there are shown an operation information storage DB 16, a display unit 17, data input means 18, a Web server 2 of an evaluation-targeted site (hereinafter, referred to as evaluation-targeted server), an evaluator terminal 3, and the Internet 4.

In FIG. 1, the proxy sever 1, evaluation-targeted sever 2 and evaluator terminal 3 are connected through a network, for example, the Internet 4 so that they can access to each other. The evaluation-targeted server 2 provides contents that are to be evaluated by the evaluator at the evaluator terminal 3. The proxy server 1 acts as an intermediary between the evaluation-targeted sever 2 and the evaluator terminal 3.

The proxy sever 1 is connected through the network connection unit 13 to the Internet 4. The proxy sever 1 has databases of the operation information storage DB 16, the user management DB 15 and the evaluation content management DB 14. The operation information storage DB 16 stores the evaluation contents as operation information obtained when the evaluator operates buttons or operates for inputting. The user management DB 15 stores the evaluator's information (the identification information (ID), names and addresses of the evaluators) for use in managing the information of evaluators. The evaluation content management DB 14 stores the information necessary for the evaluator to operate when evaluating (hereinafter, referred to as display information). In addition, the proxy server 1 has the display unit 17 for use as a monitor for the information associated with these databases 14 through 16, and as another monitor for inputting necessary data through the data input means 18. Moreover, the proxy sever 1 has the main memory 12 for temporarily storing data that is transmitted or received through the network connection unit 13. The CPU 11 controls or manages each of the devices given above to operate.

When the evaluator evaluates contents, the request for this operation (evaluation start request) is sent from the evaluator terminal 3 to the proxy server 1. The proxy server 1 receives this request information through the network connection unit 13 under the control of CPU 11. This request information is once stored in the main memory 12. The CPU 11 identifies the content of this request, and judges whether this request information has been sent from any one of the evaluators according to the user management DB 15. After the above processes, the CPU 11 generates information of request for evaluation-targeted content, and transmits it from the network connection unit 13 through the Internet 4 to the evaluation-targeted server 2. The evaluation-targeted server 2 responds to this request to transmit the requested contents through the Internet 4 to the proxy server 1.

The proxy sever 1 receives this evaluation-targeted content through the network connection unit 13, and causes the main memory 12 to temporarily store it. The CPU 11 causes the evaluation content management DB 14 to read out information (or display information) necessary for the evaluator to evaluate this evaluation-targeted content. Then, the CPU 11 controls it and the evaluation-targeted content held in the main memory 12 to be transmitted together to the evaluator terminal 3 from the network connection unit 13 through the Internet 4.

When the evaluation-targeted content and the display information are transmitted from the proxy sever 1 to the evaluator terminal 3, the evaluator evaluates this evaluation-targeted content on the basis of this display information. The resulting evaluation data is transmitted as operation information to the proxy server 1 through the Internet 4. The proxy server 1 causes this evaluation data to be stored in the operation information storage DB 16 through the network connection unit 13 and main memory 12 under the control of CPU 11. In addition, by actuating an operating portion not shown, it is also possible that the CPU 11 controls necessary evaluation data to be read out from the operation information storage DB 16, analyzes this data, and then controls the display unit 17 to indicate the analyzed data or a printer not shown to print out this data. This analyzed data can also be displayed on a display unit of another terminal connected through the Internet 4. Thus, the evaluation-targeted server 2 can improve the evaluation-targeted content according to the results of analyzing the evaluation data.

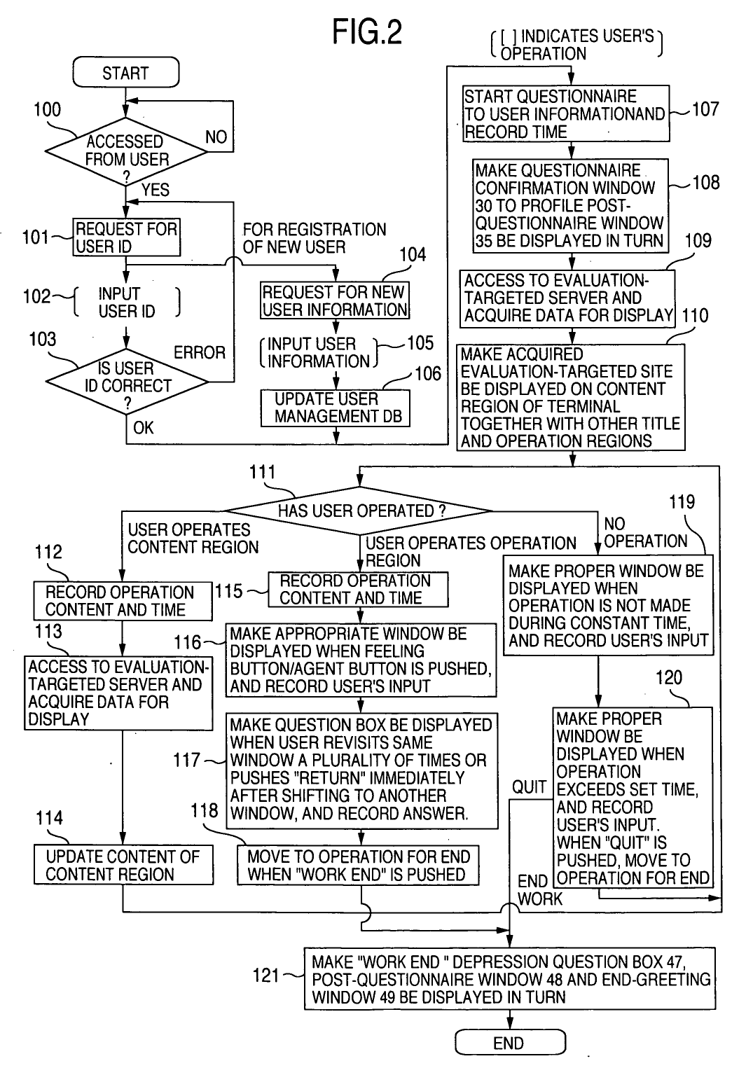

The operation of proxy sever 1 shown in FIG. 1 will be described with reference to FIG. 2.

Referring to FIGS. 1 and 2, when the power to the proxy server 1 is turned on to start the proxy server 1, the proxy server 1 is placed under the state of waiting for access from evaluator terminal 3. When an access to the proxy server 1 occurs (step 100), the proxy server 1 requests the terminal 3 to send the ID (user ID) of the evaluator (step 101). If the evaluator has the user ID and enters it in the evaluator terminal 3 (step 102), the proxy server 1 checks the ID (step 103). If the ID is error, the program goes back to step 101, where the proxy sever 1 again requests the terminal 3 to send the user ID. If the evaluator (new user) has no ID, the proxy sever 1 requests the new user to enter predetermined information (personal information of new user) for user registration after the indication of no ID (step 104). If this information is entered (step 105), the proxy server 1 registers the inputted data in the user management DB 15, thus updating the database, and gives user ID to this evaluator (step 106).

If the evaluator enters the correct user ID (step 103), or if the new user is registered as one of the evaluators of the user management DB 15 (step 106), information of the evaluator (user information or user ID) is stored in the operation information storage DB 16. In addition, operation for questionnaire (evaluation about the evaluation-targeted content sent from evaluation-targeted server 2) is started. Thus, information of date and time (information of questionnaire start time) obtained from a timer incorporated in the proxy server 1 is also stored in the operation information storage DB 16 (step 107). The information about the evaluation operations of this evaluator is classified as operation information associated with this user information, and stored in the operation information storage DB 16. Thus, if the proxy server 1 treats a plurality of evaluators, evaluation content is sorted out and stored together with the corresponding evaluator.

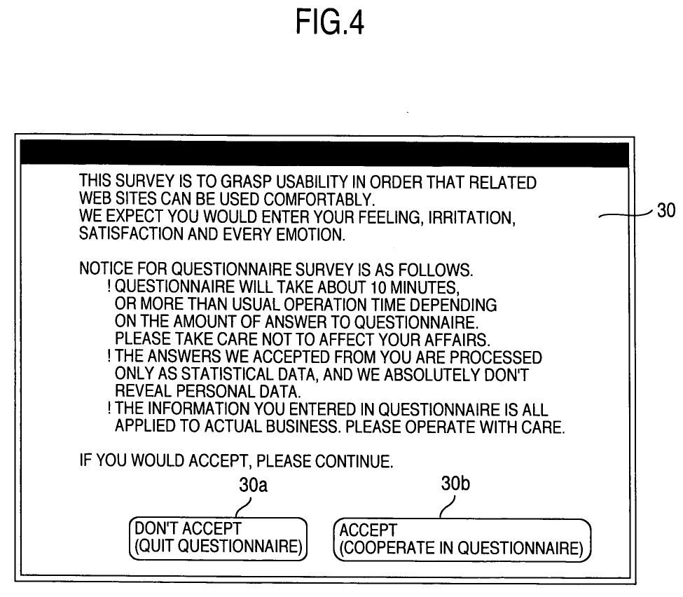

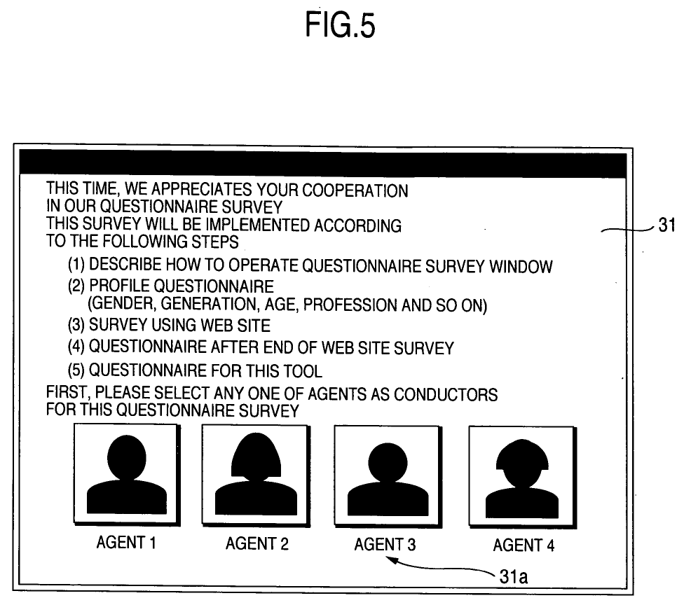

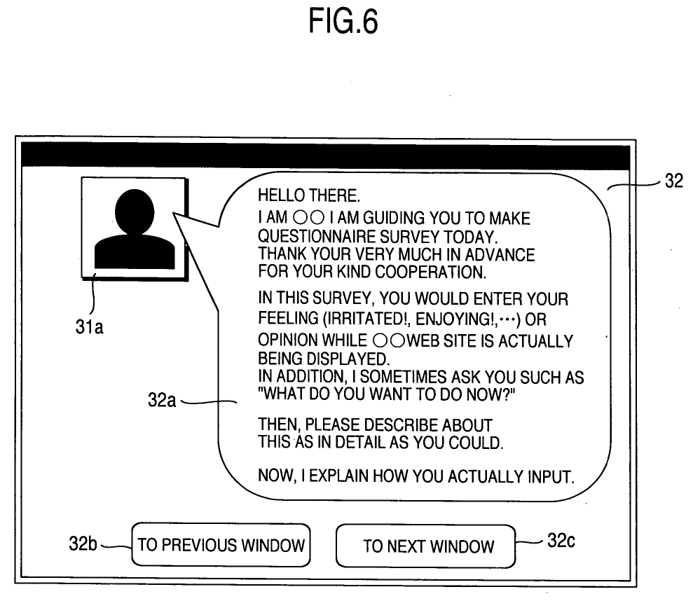

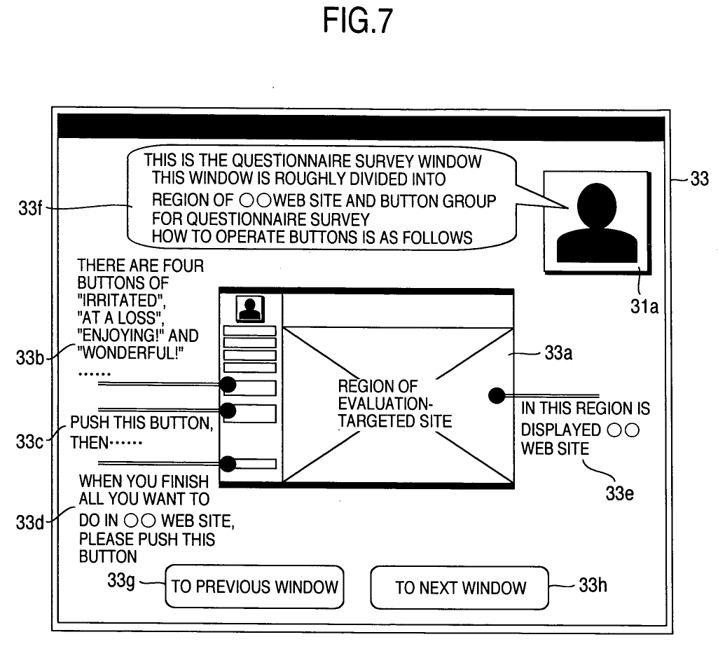

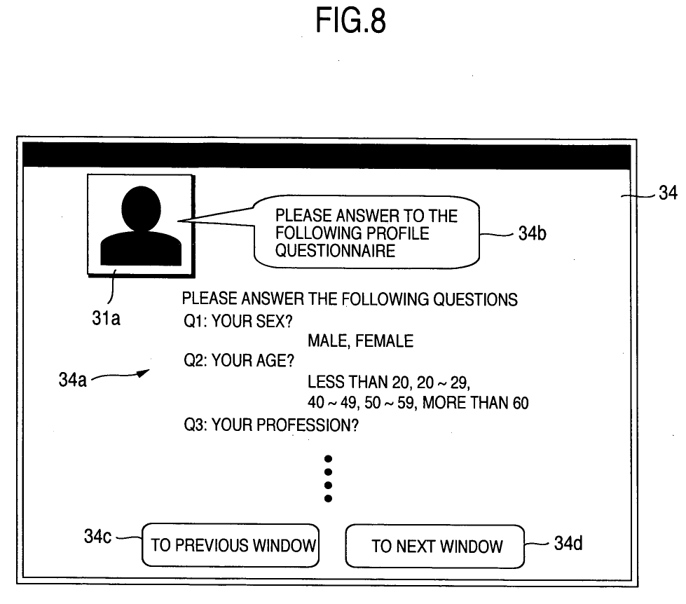

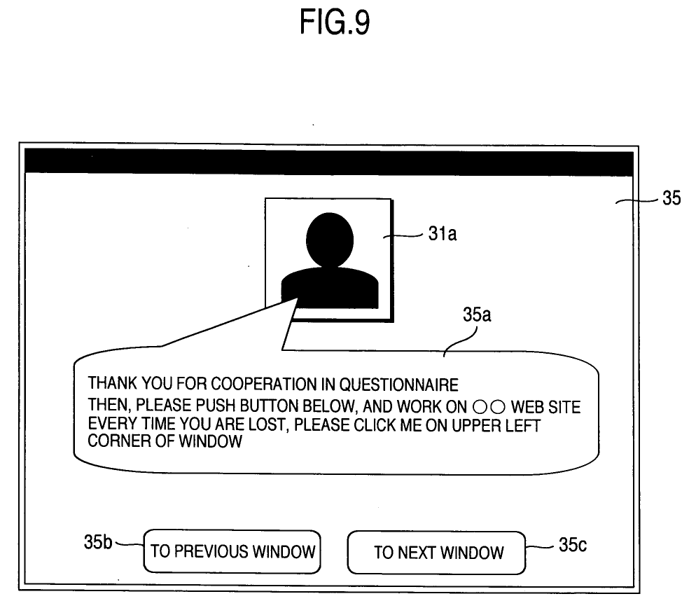

When the operation starts, the proxy server 1 controls the evaluation content management DB 14 to read out display information of a questionnaire implementation confirmation dialog box 30 (FIG. 4) which will be described later, and causes it to be transmitted to the evaluator terminal 3. Thus, as will be described later, the questionnaire implementation confirmation dialog box 30 is displayed on the evaluator terminal 3. If the evaluator makes certain operations to agree to cooperate in the questionnaire, the evaluator terminal 3 requests for the next display information. The proxy server 1 responds to this request to make the next display information be read out from the evaluation content management DB 14 and be transmitted to the evaluator terminal 3. Thus, the evaluator operates on the image as a dialog box displayed on the terminal 3 (and hence the evaluator terminal 3 transmits operation information). The proxy sever 1 transmits the display information to the evaluator terminal 3. The transmission of alternate display information and operation information is thus repeated between the evaluator terminal 3 and the proxy sever 1. Therefore, the evaluator terminal 3 sequentially receives an agent selection dialog box 31 shown in FIG. 5, an agent-greeting window 32 shown in FIG. 6, an operation guide window 33 shown in FIG. 7, a profile questionnaire dialog box 34 shown in FIG. 8, and a post-questionnaire window 35 shown in FIG. 9. The evaluator operates on each of the received images (step 108).

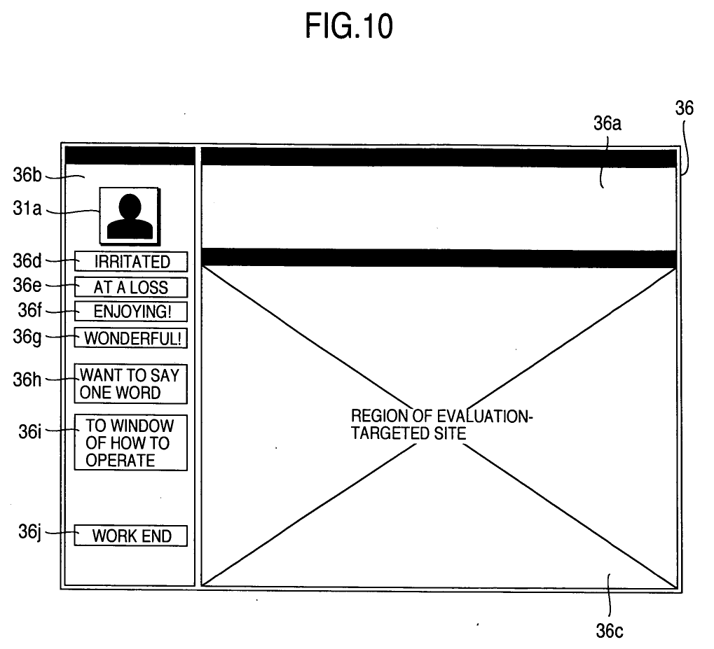

When the evaluator operates to progress on the post-questionnaire window 35, the proxy server 1 makes access to the evaluation-targeted server 1, thus acquiring evaluation-targeted content (step 109). Then, the proxy sever 1 forces this evaluation-targeted content and the corresponding display information read out from the evaluation content management DB 14 to be transmitted to the evaluation terminal 3 so that a survey window 36 can be displayed on the terminal 3 as shown in FIG. 10 (step 110).

This survey window 36 contains a title-indicating region 36a, an operation region 36b and a content-indicating region 36c as will be later described in detail. The content-indicating region 36c is used to indicate the evaluation-targeted content fed from the evaluation-targeted server 2 (for example, the window for the content is opened). The title-indicating region 36a is used to indicate the title of this evaluation-targeted content. The operation region 36b has feeling input buttons 36d-36h provided for the evaluator to input his or her emotion experienced when browsing the evaluation-targeted content, a photograph of agent 31a as a help button and other operation buttons.

When the content-indicating region 36c is operated on this survey window 36 (step 111), the operation content and the information of date and time are transmitted from the evaluator terminal 3. The proxy server 1 receives them and causes the evaluation content management DB 14 to store them (step 112). Then, the proxy sever 1 makes access to the evaluation-targeted server 1 to acquire the evaluation-targeted content (step 113), and makes it be transmitted to the evaluation terminal 3, thus updating the evaluation-targeted content indicated in the content-indicating region 36c (step 114). Then, the proxy server 1 waits for the next button operation (step 111).

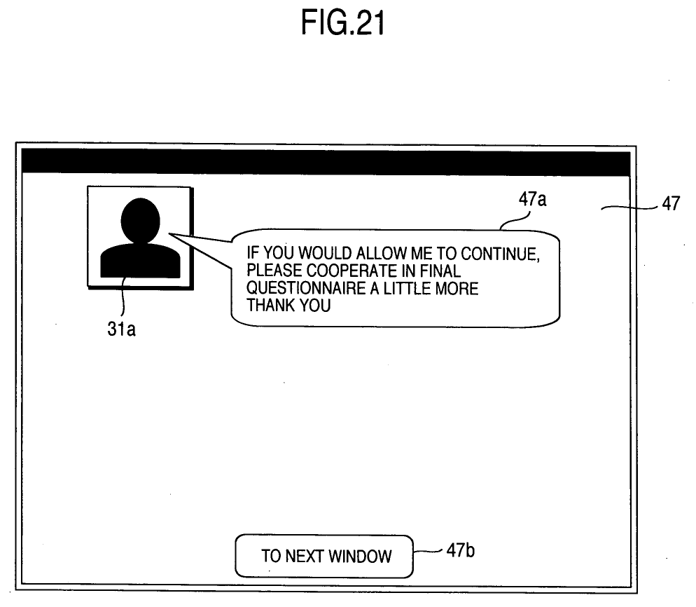

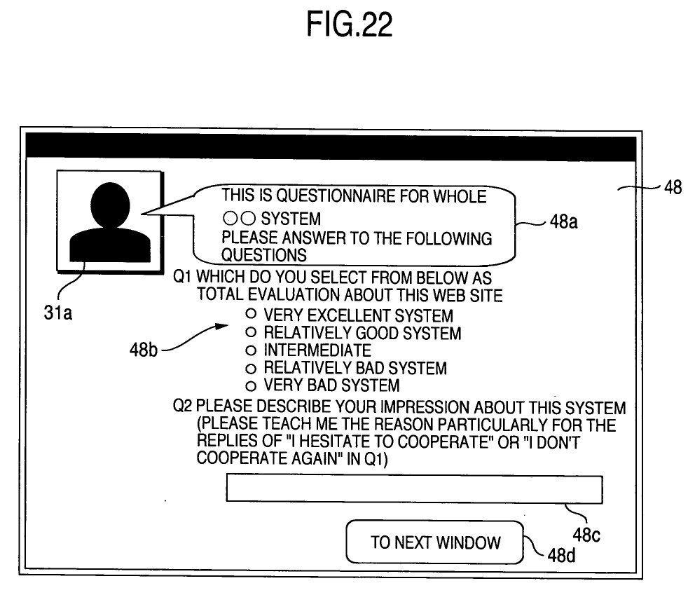

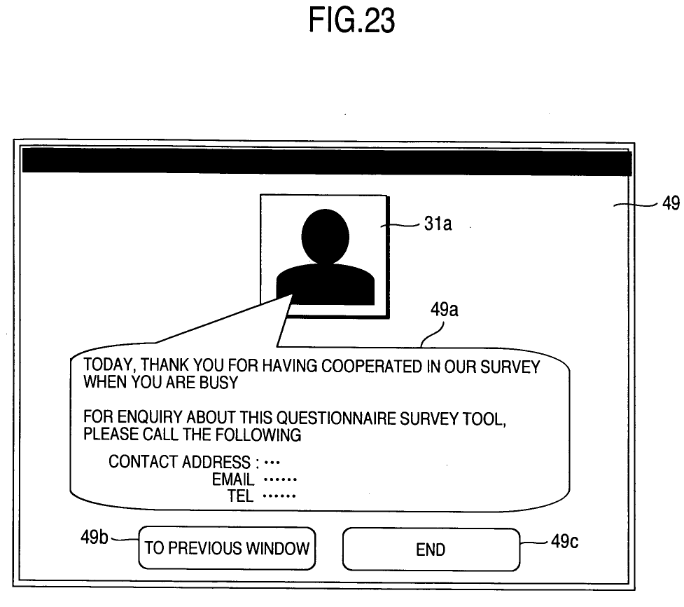

When the operation region 36b of the survey window 36 is operated (step 111), the operation content is transmitted as operation information from the evaluator terminal 3. The proxy server 1 receives this information, and causes the operation information storage DB 16 to store it together with the information of date and time acquired from the built-in timer (step 115). If this operation content is the operation of feeling input buttons 36d-36h or facial portrait of agent 31a, an image (window) corresponding to this operation is displayed. The information of the evaluator's operation on the window or input operation is taken in and stored together with the information of date and time in the operation information storage DB 16 (step 116). If the operation content in step 115 is like the case when the same window comes a plurality of times or “RETURN” button is clicked immediately after the window transition as will be later described in detail, a dialog box according to this operation is displayed as described later. The content of the answer to the question in the dialog box is taken in, and stored together with the information of date and time in the operation information storage DB 16 (step 117). After the above operations, when “WORK END” button 36j is clicked on the survey window 36 (step 118), a “WORK END” button depression question box 47 (FIG. 21), a post-questionnaire dialog box 48 (FIG. 22) and an end-greeting window 49 (FIG. 23) are displayed in turn (step 121), and the work ends. Even in the dialog boxes 47 and 48, buttons are clicked, and information about this operation or input information is taken in and transmitted to the proxy server 1. The received information and the information of date and time fed from the built-in timer are stored in the operation information storage DB 16.

In addition, if the user lets the window 36 alone without doing anything for a certain time under the waiting condition (step 111), an arousing window for that state is displayed on the evaluator terminal 3. If the user makes an input operation, the operation information indicative of this operation content is taken in and transmitted to the proxy server 1. The received information is stored together with the information of date and time in the evaluation content management DB 14 (step 119). If a predetermined time has elapsed without any operation, a dialog box indicative of this state is displayed on the evaluator terminal 3, urging the user to continue or quit the work (step 120). To continue, the waiting state (step 111) is brought about for waiting for the user to operate buttons. If the user wants to quit the work, the program goes to step 121, and ends.

Each time the evaluator makes an operation on each dialog box, the operation information indicative of that content (the kinds of clicked operation buttons, information of selected items, and input information of comment) is transmitted together with the request for the next display information to the proxy server 1 from the evaluator terminal 3. The proxy server 1 forces the operation information storage DB 16 to store the received operation information together with the information of date and time. In addition, the proxy server 1 causes the next display information to be read out from the evaluation content management DB 14, and to be transmitted to the evaluator terminal 3 where the next dialog box is displayed.

The dialog boxes displayed on the terminal 3 and the evaluator's operations in this embodiment will be described below.

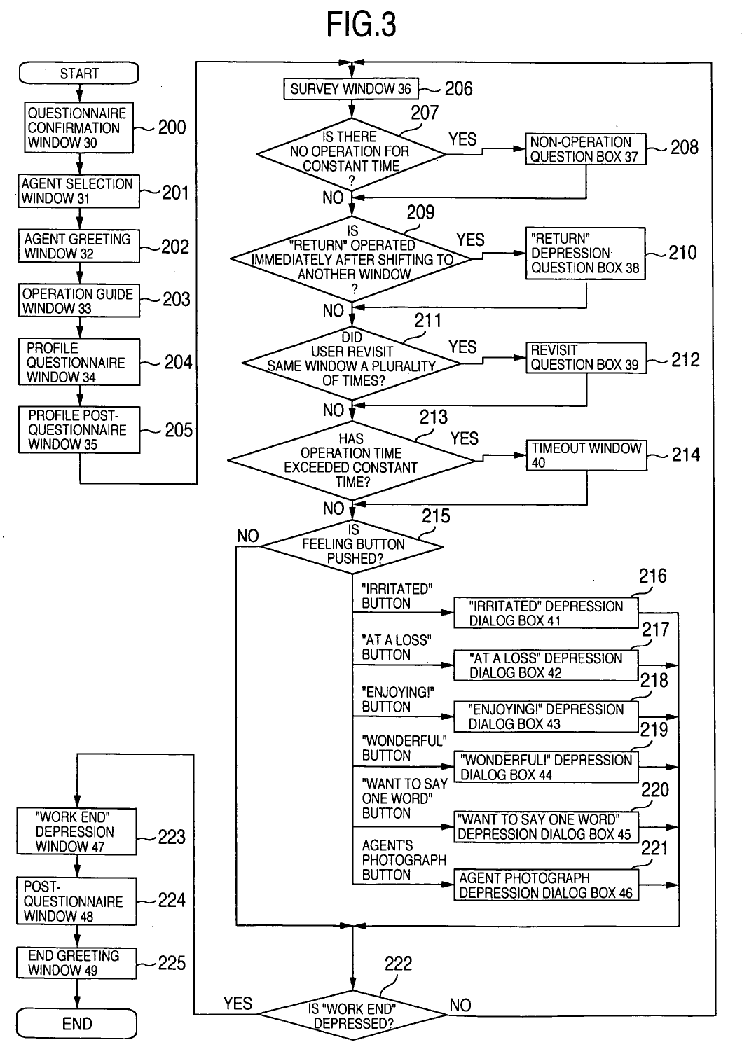

FIG. 3 is a flowchart of a specific example of the operation procedure. FIGS. 4 through 23 show examples of the dialog boxes displayed on the evaluator terminal 3 when the operation processes are executed.

When the proxy server 1 sends the evaluation-targeted content and display-information (also including information of the above dialog box) in response to the request from the evaluator terminal 3, the evaluator terminal 3 makes the operations shown in FIG. 3.

Referring to FIG. 3, first the questionnaire implementation confirmation dialog box 30 shown in FIG. 4 is displayed on the terminal 3 according to the display information from the proxy server 1 (step 200). This window 30 describes the objective of the questionnaire and the notice (it says that about 10 minutes will be taken for the questionnaire survey, etc.) in the implementation of this questionnaire. A “DISAGREE” button 30a and an “AGREE” button 30b are provided in the window 30. The evaluator is urged to select any one of the buttons. The operation for selecting a button may be made by clicking or by touching the touch panel provided otherwise. The way to operate the buttons in each of the following dialog boxes is the same as above.

If the “DISAGREE” button 30a is selected in this confirmation window 30, the survey ends. If the “AGREE” button 30b is selected, the operation information indicating that this button has been pushed is transmitted from the terminal 3 to the proxy server 1, requesting for the next display information. The proxy server 1 causes this received information and the information of date and time read from the built-in timer to be stored together in the operation information storage DB 16. In addition, the proxy server 1 forces the next display information to be read out from the evaluation content management DB 14, and to be transmitted to the evaluator terminal 3. The transmission and reception of such information is carried out each time the evaluator operates any button in each dialog box displayed on the terminal 3. Thus, since the description of the button operation for each dialog box is redundant, it will be omitted except for cases of necessity.

An agent selection menu 31 shown in FIG. 5 is displayed on the terminal 3 according to this display information (step 201). This agent selection menu 31 briefly describes the procedure of the questionnaire survey, and photographs 31a of agents who guide for the questionnaire survey. The evaluator is urged to select one of the agents. Here, photographs 31a of four agents 1 through 4 are displayed. When selecting an agent, the evaluator feels like getting the impression of help from the agent, and does not feel unnecessary tension because the agent does not actually meet the evaluator.

If any one of the agents is selected on this agent selection menu 31, an agent greeting dialog box 32 shown in FIG. 6 is displayed on the terminal 3 according to the next display information sent from the proxy server 1 (step 202). This agent greeting dialog box 31 includes the photograph 31a of the agent selected on the agent selection menu 31, and a speech balloon 32a as the greeting of this agent. The greeting may be said by voice or by both voice and balloon 32a. This greeting description includes the contents of the questionnaire (evaluation-targetted questionnaire) and the objective of the questionnaire. This questionnaire is also directed to the acquisition of the feelings that the evaluator has during the questionnaire survey, and this fact is described as the objective of the questionnaire.

In addition, this agent greeting dialog box 32 has a “TO PREVIOUS WINDOW” button 32b and a “TO NEXT WINDOW” button 32C provided so that any one of them can be selected. When the evaluator wants to newly select another agent or reconfirm the notice of the questionnaire survey, the “TO PREVIOUS WINDOW” button 32b is operated to bring back the agent selection menu 31 shown in FIG. 5.

When the “TO NEXT WINDOW” button 32c is selected from the agent greeting dialog box 32, an operation guide window 33 shown in FIG. 7 appears on the terminal 3 according to the next display information sent from the proxy server 1 (step 203). This operation guide window 33 has a survey window 33a including the actual evaluation-targeted contents, and introductory and explanatory statements 33b through 33e. In addition, the selected agent's photograph 31a is displayed, speaking by balloon 33f or voice. This operation guide window 33 has a “TO PREVIOUS WINDOW” 33g and a “TO NEXT WINDOW” 33h provided so that any one of them can be selected. When the evaluator wants to reselect another agent or reconfirm the notice of the questionnaire survey, the “TO PREVIOUS WINDOW” button 33g is operated to bring back the agent greeting window 32 (FIG. 6).

When the evaluator selects the “TO NEXT WINDOW” button 33h on the operation guide window 33, a profile questionnaire dialog box 34 shown in FIG. 8 is displayed on the evaluator terminal 3 according to the next display information sent from the proxy sever 1 (step 204). This profile questionnaire dialog box 34 is provided to urge the evaluator to input his or her profile. When the user management DB 15 (see FIG. 1) of the proxy server 1 does not include data of this evaluator, the evaluator is urged to enter the data of this evaluator (profile data) in the profile questionnaire dialog box 34. The profile questionnaire dialog box 34 has questions 34a necessary for user management. Each question has appropriate choices to mark and spaces to enter words. In addition, the selected agent's photograph 31a is also displayed, speaking by balloon 34b or voice for cooperation in the profile questionnaire. This profile questionnaire dialog box 34 has a “TO PREVIOUS WINDOW” button 34c and a “TO NEXT WINDOW” button 34d provided so that any one of them can be selected. If the “TO PREVIOUS WINDOW” button 34c is selected, the previous agent greeting dialog box 33 (see FIG. 7) can be brought back.

When the “TO NEXT WINDOW” button 34d is selected from the profile questionnaire window 34, the evaluator terminal 3 transmits information indicative of having selected the “TO NEXT WINDOW” button 34d, and information of the selected items of questions 34a as the operation information to the proxy server 1 (see FIG. 1), requesting for the next display information. For other windows having such questions, the same operations as above are made although the description of the related operations is omitted here.

Thus, a post-questionnaire window 35 shown in FIG. 9 is displayed on the terminal 3 according to the display information sent from the proxy server 1 (step 205). This post-questionnaire window 35 has the agent's photograph 31a displayed speaking by balloon 35a or voice. The evaluator is thus notified of having finished the profile questionnaire and of now progressing to the process for evaluating the evaluation-targeted content. This agent's photograph 31a has another function as a help button of which the evaluator is informed. This post-questionnaire window 35 has a “TO PREVIOUS WINDOW” button 35b and a “TO NEXT WINDOW” button 35c provided so that any one of them can be selected. If the previous profile questionnaire window 34 (see FIG. 8) is desired to bring back, the “TO PREVIOUS WINDOW” button 35b is operated.

If the “TO NEXT WINDOW” BUTTON 35c is selected on the post-questionnaire dialog box 35, a survey window 36 shown in FIG. 10 is displayed on the evaluator terminal 3 according to the display information fed from the proxy server 1 (step 206). This survey window 36 has a title region 36a, an operation region 36b and a content region 36c. The content region 36c is used to display the evaluation-targeted content fed from the evaluation-targeted server 2. The title region 36a is used to display the title of this evaluation-targeted content.

The operation region 36b is used to display the agent's photograph 31a selected to serve as a help button, and different kinds of feeling input buttons. The evaluator selects any one of the feeling input buttons according to the emotions he or she experiences when working on the evaluation of the content. These feeling input buttons include an “IRRITATED” button 36d, an “AT A LOSS” button 36e, an “ENJOYING!” button 36f, a “WONDERFUL!” button 36g, and a “WANT TO SAY ONE WORD” button 36h. The operation region 36b also include a “TO OPERATION GUIDE WINDOW” button 36i for use in progressing to the operation guide window, and a “WORK END” button 36j for finishing the work on this survey window 36.

The operation guide window displayed by selecting the “TO OPERATION GUIDE WINDOW” button 36i is not shown, but the same as the operation guide window 33 shown in FIG. 7. However, the “TO PREVIOUS WINDOW” button and “TO NEXT WINDOW” button are not provided, but a “RETURN” button is provided. When the evaluator checks the operation procedure described in the operation guide window, and then selects this “RETURN” button, the survey window 36 reappears.

These feeling input buttons 36d through 36h and the photograph 31a are provided in order to acquire the feelings that the evaluator shows while browsing the evaluation-targeted content of the content region 36c. The evaluator can select any one of these buttons when this survey window 36 starts to show. When the evaluator selects a button according to the feelings, the selected feeling input button immediately responds to this action. If the evaluator feels irritated about the evaluation-targeted content while browsing it, and pushes the “IRRITATED” button 36d, the evaluator terminal 3 acquires the “IRRITATED” information (emotion data) and transmits this information (operation information indicative of having selected the “IRRITATED” button 36d) to the proxy server 1, thus requesting for the display information corresponding to this feeling input button 36d. If other feeling input buttons are operated, the terminal 3 acts in the same way. The proxy server 1 receives this information from the evaluator terminal 3, and forces this information and the information of date and time fed from the built-in timer to be stored in the operation information storage DB 16.

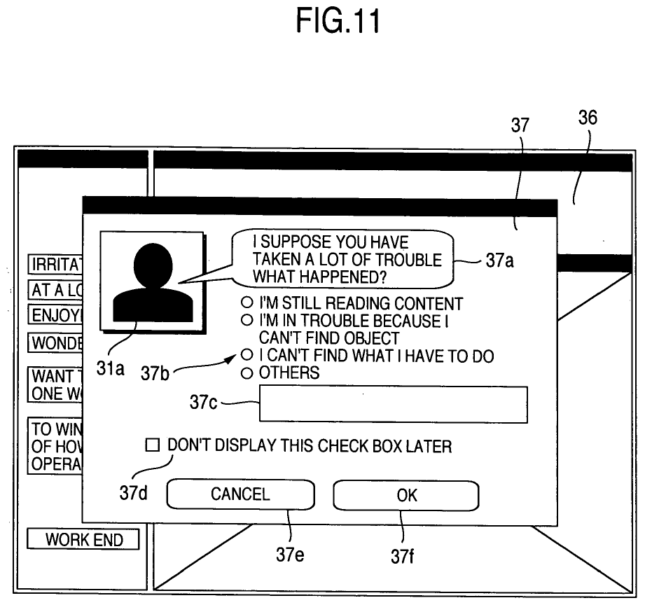

Under the state that this survey window 36 is being displayed, if the user does not select any one of the buttons provided within the operation region 36d for a certain period of time (step 207), display information for that case is transmitted from the proxy server 1. This display information causes a non-operation question window 37 to be opened over the survey window 36 as shown in FIG. 11 (step 208). The non-operation question window 37 shows the photograph 31a of the selected agent who is speaking to the evaluator by balloon 37a or voice as “what's going on”, and examples of the answer 37b to this inquiry so that the evaluator can answer (or select an example of the answer). If the answer of “OTHERS” is selected as an example of the answer 37b, the reason for this selection can be filled in the reply field 37c. In addition, if the evaluator enters a check mark in a check box 37d of “DON'T OPEN THIS WINDOW LATER”, this non-operation question window 37 can be controlled not to open next time. Moreover, if a “CANCEL” button 37e is pushed, the information inputted so far in the non-operation question window 37 can be cancelled out. When the evaluator completely inputs necessary information in the non-operation question window 37, and selects “OK” button 37f, the window 37 is closed, and the survey window 36 shown in FIG. 10 is brought back (steps 209, 211, 213, 215, 222 and 206).

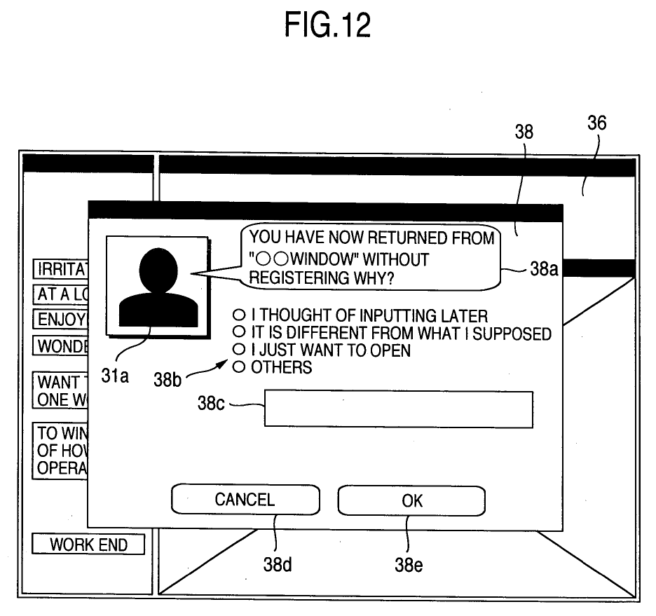

In addition, if the evaluator makes operation to return to the original window as soon as he or she selects a window to open on the survey window 36 during the time of browsing the evaluation-targeted content (step 209), the display information corresponding to this operation is transmitted from the proxy server 1. The terminal receives this display information, and displays thereon a “RETURN” depression dialog box 38 over the survey window 36 according to this display information as shown in FIG. 12 (step 210). The “RETURN” depression dialog box 38 shows the selected agent's photograph 31a that is speaking by balloon 38a or voice to the evaluator as “what's going on” and examples of answer 38b to this inquiry so that the evaluator can answer (or select an example of the answer). If “OTHERS” is selected as an example of the answer 38b, the reason for this selection can be specifically filled in the reply field 38c. If “CANCEL” button 38d is selected, the information inputted so far in this “RETURN” depression dialog box 38 is cancelled out. If the evaluator completely enters necessary information in the dialog box 38, and selects a “OK” button 38e, the dialog box 38 is closed, and the survey window 36 shown in FIG. 10 is brought back to fully appear (steps 211, 213, 215, 222, and 206).

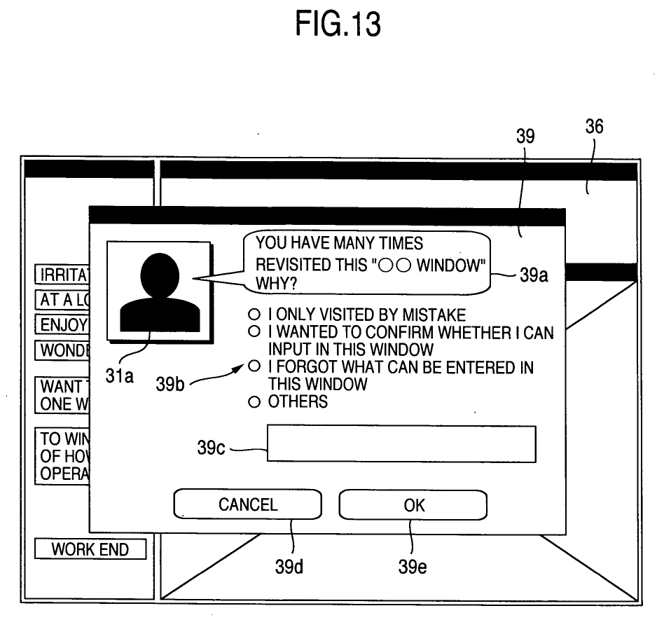

In addition, if buttons were depressed again and again within the content region 36c of the survey window 36, images (contents) appear or disappear, or change so that the same image might be displayed a certain number of times. Alternatively, if the evaluator selects any one of the feeling input buttons 36d through 36h, a dialog box will be displayed in response to the depressed feeling input button. In this case, if the evaluator answers to the questions of the dialog box, the survey window 36 will be brought back to fully appear. Thus, as described later, each time the survey window appears, the same dialog box may be sometimes repeatedly displayed a certain number of times as a result of, for example, selecting the same feeling input button. The same dialog boxy will also be displayed a certain number of times in response to other selecting operations. If the same dialog box is displayed a certain number of times as above (step 211), the display information corresponding to this operation is transmitted from the proxy server 1. This display information is used to cause a revisit dialog box 39 to open over the survey window 36 as shown in FIG. 13 (step 212). The revisit dialog box 39 shows the selected agent's photograph 31a that is speaking by balloon 39a or voice to the evaluator as what happened, and examples of answer 39b to this inquiry so that the evaluator can answer (or select an example of the answer). If “OTHERS” is selected as an example of the answer 39b, the reason for this selection can be specifically filled in the reply field 39c. If a “CANCEL” button 39d is selected, the information inputted so far in this revisit dialog box 39 is cancelled out. If the evaluator completely enters necessary information in the dialog box 39, and selects a “OK” button 39e, the dialog box 39 is closed, and the survey window 36 shown in FIG. 10 is brought back to fully appear (steps 213, 215, 222, and 206).

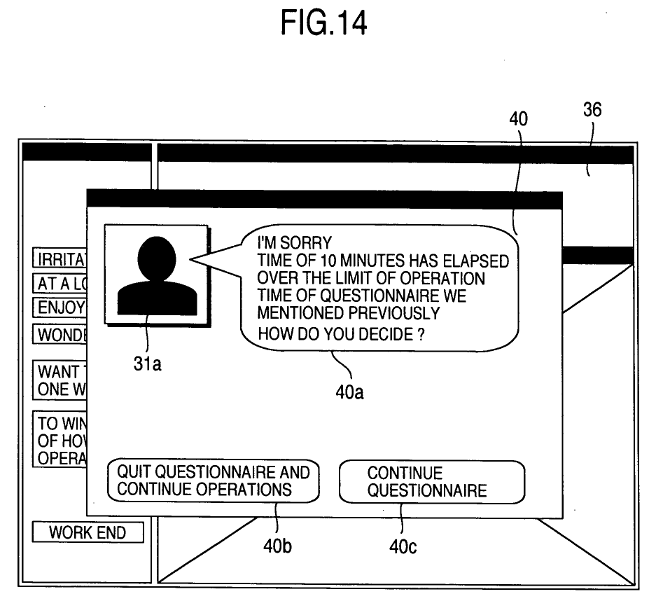

Moreover, the questionnaire survey using this survey window 36 should be completely performed within a predetermined period of time (here, about 10 minutes) as described in the questionnaire implementation confirmation dialog box 30 previously shown in FIG. 4. If the “WORK END” button 36j is not selected yet even when more than a predetermined period of time elapses after the survey window 36 has been displayed (step 213), the display information corresponding to this case is transmitted from the proxy server 1. When the terminal receives this display information, it displays thereon an operation timeout window 40 over the survey window 36 according to this display information as shown in FIG. 14 (step 211). The operation timeout window 40 shows the selected agent's photograph 31a that is speaking by balloon 40a or voice to the evaluator about the timeout of the operation and inquiring about what you are trying to do next. In addition, the window 40 shows buttons such as “QUIT QUESTIONNAIRE AND MAKE NEXT OPERATION” button 40b and “CONTINUE QUESTIONNAIRE” BUTTON 40c so that the evaluator can select any one of the buttons. If the “QUIT QUESTIONNAIRE AND MAKE NEXT OPERATION” button 40b is selected, the questionnaire survey is stopped. If the “CONTINUE QUESTIONNAIRE” BUTTON 40c is selected, the survey window 36 shown in FIG. 10 is brought back to fully appear (steps 215, 222 and 206).

The steps 207, 209, 211 and 213 are performed as above after the step 206 where the survey window 36 is displayed, but similarly executed even after other window, or after window 33 shown in FIG. 7 where an agent is already selected.

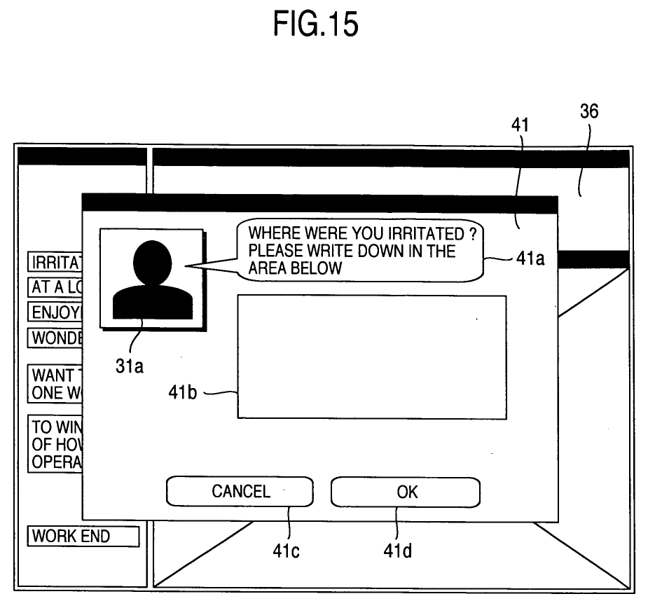

It is assumed that the evaluator feels irritated while browsing the evaluation-targeted content shown within the content region 36c, and then pushes the feeling input button corresponding to this emotion, or the “IRRITATED” button 36d on the survey window 36 shown in FIG. 10 (step 215). Then, the display information corresponding to this case is sent from the proxy server 1, and received by the terminal to make a “IRRITATED” depression dialog box 41 be opened as a feeling input dialog box over the survey window 36 as shown in FIG. 15 (step 216). This “IRRITATED” depression dialog box 41 shows the selected agent's photograph 31a that is asking the evaluator by balloon 41a or voice to specifically write down the reason for the irritation in a description field 41b. The evaluator describes the reason for the irritation in the field 41b according to the request, and clicks the “OK” button 41d. Then, the information indicating that this selection operation has been done and the input information filled within the field 41b are transmitted as operation information to the operation information storage DB 16 (see FIG. 1) of the proxy server 1. In addition, this “IRRITATED” depression dialog box 41 is closed, thus the survey window 36 shown in FIG. 10 being brought back to fully appear (steps 222 and 206). If the “CANCEL” button 41c is selected, the information inputted so far in this field 41b is cancelled out. The information indicating that this selection operation has been done is transmitted to the operation information storage DB 16 (see FIG. 1) of proxy server 1. Thus, the irritated feeling can be inputted as detailed information for the feeling at the time when this actually occurs. The system side can also acquire the emotion that the evaluator has actually experienced.

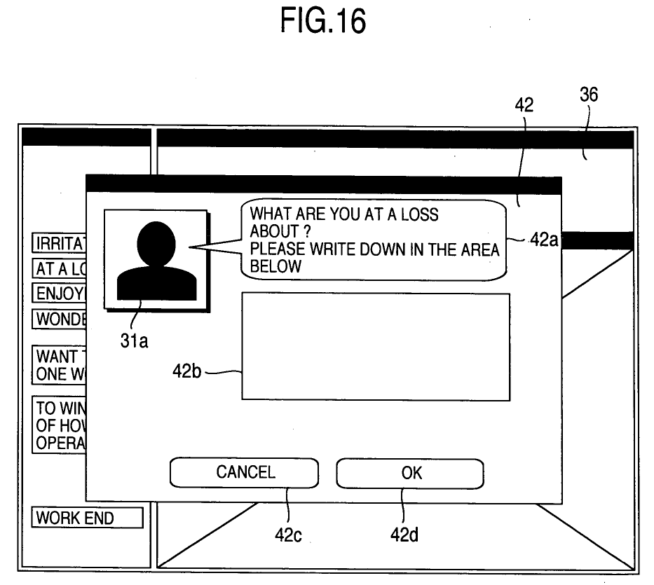

It is assumed that the evaluator is hard pressed for some kind of reason while browsing the evaluation-targeted content displayed within the content region 36c, and selects the “AT A LOSS” button 36e on the survey window 36 shown in FIG. 10 (step 215). Then, the display information corresponding to this selection is transmitted from the proxy server 1, and received to cause a “AT A LOSS” depression dialog box 42 to be opened as a feeling input window over the survey window 36 as shown in FIG. 16 (step 217). This “AT A LOSS” depression dialog box 42 shows the selected agent's photograph 31a that is speaking by balloon 42a or voice to the evaluator and requesting the evaluator to minutely describe about what annoyed the evaluator in a field 42b. When the evaluator writes down the reason in the field 42b, and presses an “OK” button 42d, the information indicating that this selection operation has been done and the input information written down in the field 42b are transmitted as operation information to the operation information storage DB 16 (see FIG. 1) of the proxy server 1. In addition, the “AT A LOSS” depression dialog box 42 is closed, and thus the survey window 36 shown in FIG. 10 is brought back to fully appear (steps 222 and 206). If a “CANCEL” button 42c is selected, the information inputted so far in this field 42b is cancelled out, and the information indicating that this selection operation has been done is transmitted to the evaluation content management DB 14 (see FIG. 1) of the proxy server 1. Thus, the hard-pressed feeling can be inputted as detailed information for the feeling at the time when this actually occurs. The system side can also acquire the emotion that the evaluator has actually experienced.

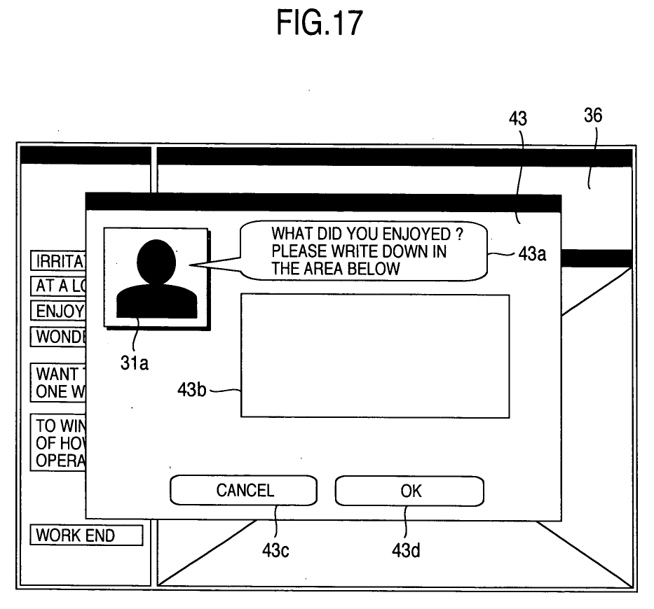

It is also assumed that the evaluator feels pleasant in the course of his or her browsing the evaluation-targeted content displayed within the content region 36c, and selects the “ENJOYING!” button 36f on the survey window 36 shown in FIG. 10 (step 215). Then, the display information corresponding to the selected button is transmitted from the proxy server 1, and received to cause a “ENJOYING!” depression dialog box 43 to be opened as a feeling input dialog box over the survey window 36 as shown in FIG. 17 (step 218). This “ENJOYING!” depression dialog box 43 shows the selected agent's photograph 31a that is speaking by balloon 43a or voice to the evaluator and requesting the evaluator to specifically describe the reason for the joviality in a field 43b. When the evaluator writes down the reason in the field 43b, and presses an “OK” button 43d, the information indicating that this selection operation has been done and the input information written down in the field 43b are transmitted as operation information to the operation information storage DB 16 (see FIG. 1) of the proxy server 1. In addition, this “ENJOYING!” depression dialog box 43 is closed, and thus the survey window 36 shown in FIG. 10 is brought back to fully appear (steps 222 and 206). If a “CANCEL” button 43c is selected, the information inputted so far in this field 43b is cancelled out, and the information indicating that this selection operation has been done is transmitted to the operation information storage DB 16 (see FIG. 1) of the proxy server 1. Thus, the delightful feeling can be inputted as detailed information for the feeling at the time when this actually occurs. The system side can also acquire the emotion that the evaluator has actually experienced.

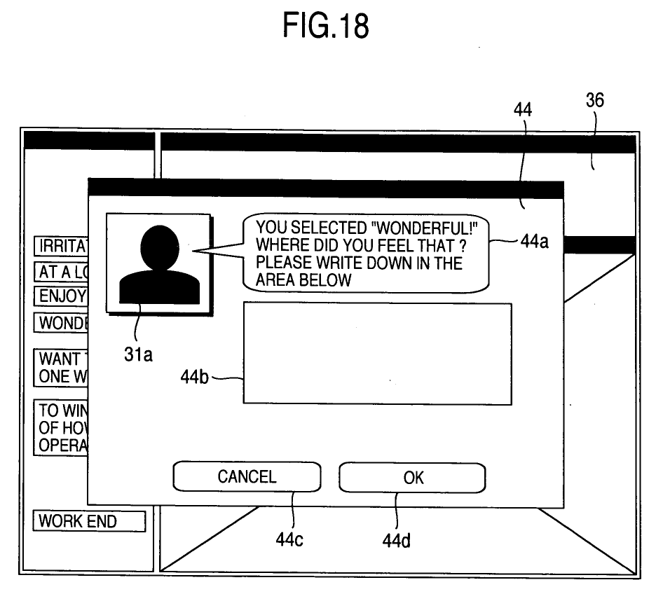

It is assumed that the evaluator feels very good about this evaluation-targeted content in the course of his or her browsing in the content region 36c, and selects the “WONDERFUL!” button 36g on the survey window 36 as shown in FIG. 10 (step 215). Then, the display information corresponding to this selected button is transmitted from the proxy server 1, and received to cause a “WONDERFUL!” depression dialog box 44 to be opened as a feeling input dialog box over the survey window 36 as shown in FIG. 18 (step 219). This “WONDERFUL!” depression dialog box 44 shows the selected agent's photograph 31a that is speaking by balloon 44a or voice to the evaluator and requesting the evaluator to specifically describe the reason for the excellence in a field 44b. When the evaluator writes down the reason in the field 44b, and presses an “OK” button 44d, the information indicating that this selection operation has been done and the input information written down in the field 44b are transmitted as operation information to the operation information storage DB 16 (see FIG. 1) of the proxy server 1. In addition, this “WONDERFUL!” depression dialog box 44 is closed, and thus the survey window 36 shown in FIG. 10 is brought back to fully appear (steps 222 and 206). If a “CANCEL” button 44c is selected, the information inputted so far in this field 44b is cancelled out, and the information indicating that this selection operation has been done is transmitted to the operation information storage DB 16 (see FIG. 1) of the proxy server 1. Thus, the excellent feeling can be inputted as detailed information for the feeling at the time when this actually occurs. The system side can also acquire the emotion that the evaluator has actually experienced.

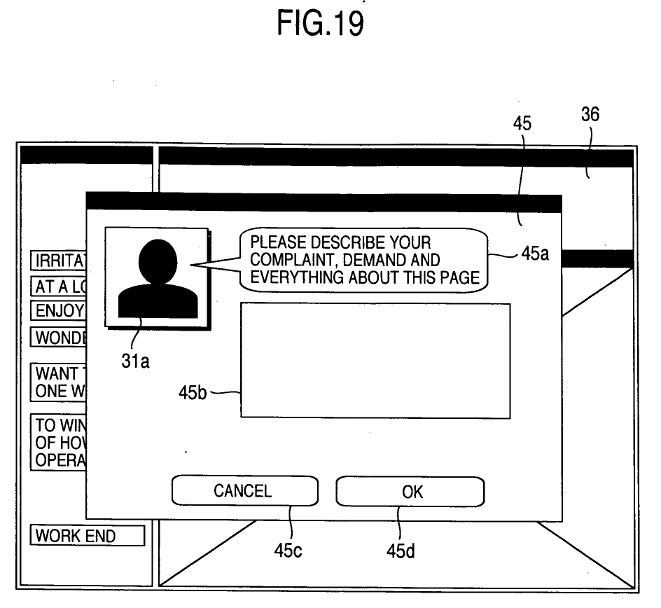

We further assume that the evaluator feels like wanting to say one word against this evaluation-targeted content while browsing the content region 36c, and selects the “WANT TO SAY ONE WORD!” button 36g on the survey window 36 as shown in FIG. 10 (step 215). Then, the display information according to the selected button is sent from the proxy server 1, and received to cause a “WANT TO SAY ONE WORD” depression dialog box 45 to be opened as a feeling input dialog box over the survey window 36 as shown in FIG. 19 (step 220). This “WANT TO SAY ONE WORD” depression dialog box 45 shows the selected agent's photograph 31a that is speaking by balloon 45a or voice to the evaluator and requesting the evaluator to specifically describe the complaints, demand and opinion about this evaluation-targeted content (page) in a field 45b. When the evaluator writes down his or her comment in the field 44b, and presses an “OK” button 45d, the information indicating that this selection operation has been done and the input information written in the field 45b are transmitted as operation information to the operation information storage DB 16 (see FIG. 1) of the proxy server 1. In addition, this “WANT TO SAY ONE WORD” depression dialog box 45 is closed, and thus the survey window 36 shown in FIG. 10 is brought back to fully appear (steps 222 and 206). If a “CANCEL” button 45c is selected, the information inputted so far in this field 45b is cancelled out, and the information indicating that this selection operation has been done is transmitted to the operation information storage DB 16 (see FIG. 1) of the proxy server 1. Thus, the feeling of wanting to say one word can be inputted as detailed information for the feeling at the time when this actually occurs. The system side can also acquire the emotion that the evaluator has actually experienced.

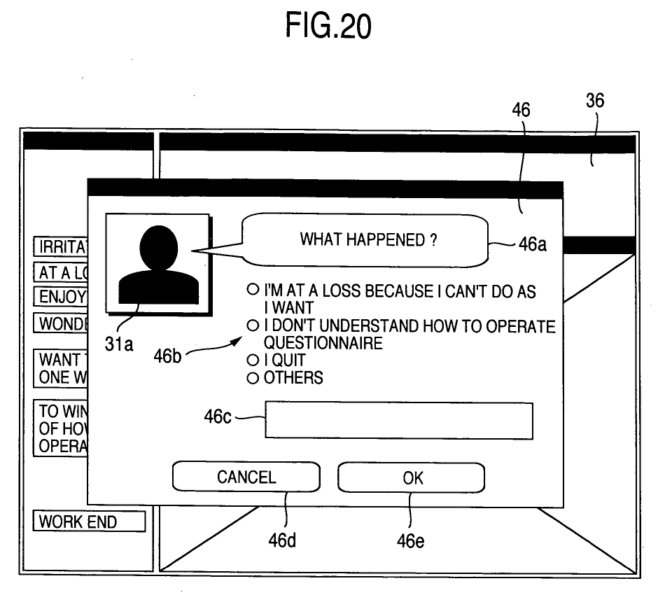

If the evaluator selects the agent' photograph 31a as a help button on the survey window 36 shown in FIG. 10 (step 215), the display information corresponding to the selection is transmitted from the proxy server 1 to cause a photograph depression dialog box 46 to be opened over the survey window 36 as shown in FIG. 20 (step 221). This photograph depression dialog box 46 shows the selected agent's photograph 31a that is speaking by balloon 46a or voice to the evaluator and inquiring as “what happened”, and examples of answer 46b to this inquiry so that any one of them can be selected. If the answer is “OTHERS”, the evaluator can specifically write down the reason in an answer field 46c. If the evaluator selects any one of the examples of answer 46b, and depresses an “OK” button 46e, the information indicating that this selection operation has been done, the selected answer 46b, and the information inputted in the field 46c are transmitted as operation information to the operation information storage DB 16 (see FIG. 1) of the proxy server 1. In addition, this photograph depression dialog box 46 is closed, and thus the survey window 36 shown in FIG. 10 is brought back to fully appear (steps 222 and 206). If a “CANCEL” button 46d is selected, the information inputted so far in this photograph depression dialog box 46 is cancelled out, and the information indicating that this selection operation has been done is transmitted to the operation information storage DB 16 (see FIG. 1) of the proxy server 1.

If the evaluator selects any one of the feeling input buttons 36d through 36h in the survey window 36 shown in FIG. 10, the program goes from step 215 through any one of steps 216˜221 to step 222, and goes back to step 206 where the survey window is displayed, unless the “WORK END” button 36j is selected. Therefore, if the “WORK END” button 36j is not selected, more than two kinds of feeling input buttons such as “IRRITATED” button 36d and “WANT TO SAY ONE WORD” button 36h can be selected.

In addition, sometimes, the evaluator thinks good of the content at first in the course of browsing the evaluation-targeted content but gradually feels irritated as the browsing goes on. This questionnaire requests the evaluator to input feelings at each time of the experience, and enables the evaluator to input in such way as above. Therefore, each time the evaluator experiences emotion, the evaluator can select “WONDERFUL!” button 36g when the evaluation-targeted content seems good, and later selects “IRRITATED” button 36d when the evaluator begins to feel irritated about the content. The proxy server 1 sends display information to the evaluator terminal 3 (see FIG. 1) when the evaluator operates buttons. At this time, the proxy server 1 causes the terminal 3 to display the survey window 36, each of the dialog boxes 37˜40 given above and “WORK END” depression dialog box 47 which will be described later. Then, the proxy server 1 also causes the information of date and time (display start time) at which the above dialog boxes are displayed to be taken in from the built-in timer not shown and stored in the operation information storage DB 16. Therefore, each time any one of the buttons such as “WONDERFUL!” button 36g and IRRITATED” button 36d is selected on the survey window 36, the information of date and time can be taken in from the built-in timer and held in the operation information storage DB 16 of the proxy server 1.

If the evaluator finishes necessary selection operations on the survey window 36 and accompanying dialog boxes 41˜46, and presses the “WORK END” button 36j (step 222), the proxy server 1 sends display information, which causes the evaluator terminal 3 to display an “WORK END” depression dialog box 47 as shown in FIG. 21 (step 223). This “WORK END” depression dialog box 47 is provided in order for the evaluator to abort the answer to the questionnaire survey for a change and to notify of the following operations. This window 47 shows the selected agent's photograph 31a that is speaking by balloon 47a or voice to the evaluator about relaxation. Then, if the evaluator selects a “TO NEXT WINDOW” button 47b, the proxy server 1 transmits display information, which causes the evaluator terminal 3 to display a post-questionnaire window 48 shown in FIG. 22 (step 224).

This post-questionnaire window 48 implements a comprehensive evaluation questionnaire of evaluated content (Web site). It includes some questions, selectable examples of answer to each of the questions, and a description field 48c for comment. In addition, it shows the selected agent's photograph 31a that is speaking by balloon 48a or voice about the guidance for the questionnaire.

If the evaluator selects a “TO NEXT WINDOW” button 48d on this post-questionnaire window 48, the proxy server 1 transmits display information in response to this action to the evaluator terminal 3, causing it to display an end-greeting window 49 shown in FIG. 23 (step 225). This end-greeting window 49 shows the selected agent's photograph that is speaking by balloon 49a or voice to the evaluator to say end greeting of the questionnaire survey. If the evaluator pushes an “END” button 49c, a series of operations of the questionnaire survey is finished. If the evaluator depresses a “TO PREVIOUS WINDOW” button 49b on the end-greeting window 49, the post-questionnaire window 48 is brought back to fully appear as shown in FIG. 22 (step 224). In this case, the answers inputted previously may be cancelled out or may be left as they are. In either case, the evaluator can again answer to the questions of the questionnaire.

If the evaluator selects the agent's photograph 31a on the windows 47˜49 shown in FIGS. 21˜23, the photograph depression dialog box 46 is opened as shown in FIG. 20 so that it can respond to the evaluator (however, the windows 47˜49 are sometimes different in content from each other).

Thus, the evaluator makes a sequence of content evaluating operations as above, during which the selected agent's photograph 31a is shown speaking by a balloon or voice to guide the evaluator about the displayed windows. Accordingly, the evaluator can make evaluation operations under the same situations as actually guided by agent. In addition, since the situations can be understood when the photograph 31a is selected (see the agent's photograph depression dialog box 46 shown in FIG. 20), the evaluator can make the evaluation operations under the same situations as accompanied by the actual agent. Furthermore, since the agent does not actually stand by the evaluator, the evaluator can make operations in a relaxed atmosphere that much. In addition, since the agent's photograph selected by the evaluator is shown in such windows, the evaluator can easily discriminate such windows from the sub-window used in the evaluation (questionnaire) of evaluation-targeted content of the opened site, thus definitely distinguishing from other windows. Therefore, since the windows used for the evaluation of content can be identified easily and not highly consciously, such windows can be avoided from being closed carelessly as unrelated windows.

The agent's photograph 31a can be replaced by other images indicative of agent's face such as agent's character except the agent's photograph.

In this embodiment, each time the operation information is produced as the results of the questionnaire (information of operated button and input information) acquired by the above operations and other necessary operation information, the evaluator terminal 3 transmits it to the proxy server 1. The proxy server 1 controls the operation information storage DB 16 to store the received information and the information of date and time taken in at that time. The information sent to the server may be kept in the evaluator terminal 3 until the questionnaire is finished (for example, until the “END” button 49c is selected on the end-greeting window 49 shown in FIG. 23). Thus, after the questionnaire is finished, the information produced at the terminal may be transmitted to the proxy server 1 and stored in the operation information storage DB 16. In this case, information of date and time may be obtained at the evaluator terminal 3 or acquired from the built-in timer of the proxy server 1. Thus, this information of date and time can be caused to be associated with the display information to be sent to the terminal 3 and hence with the operation information corresponding to this display information, and to be stored in the operation information storage DB 16.

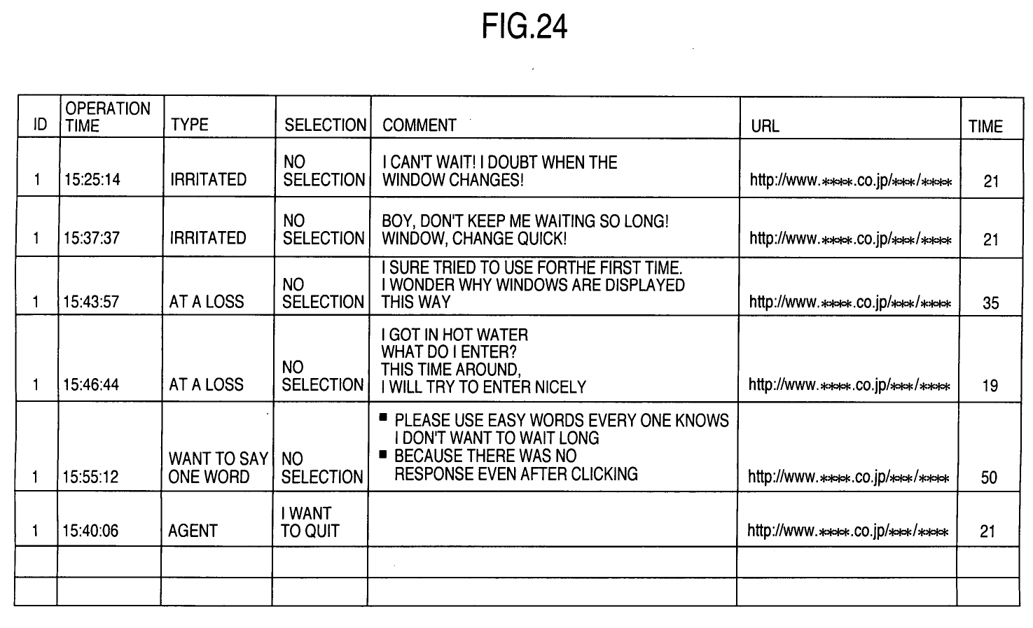

FIG. 24 shows a specific example of the recorded data of a particular user as the result of the questionnaire associated with a particular user having ID of “1” that is stored in this evaluation content management DB 14. This recorded data contains an evaluator's ID column 50, an operation (selection) time column 51 of any one or ones of the feeling input buttons 36d˜36h, an evaluator's feeling kind column 52 (or the column for the operated feeling input buttons), and an item selection column 53 showing the items that the evaluator selected on the window. The recorded data further contains a comment column 54, an URL column 55 of the evaluation-targeted content, and a time (seconds) column 56 showing the time taken for the evaluator to input his or her comment. The comment column 54 shows the content of the comment that the evaluator inputted on the displayed windows 41˜46 when depressing any one or ones of the feeling input buttons 36d˜36h.

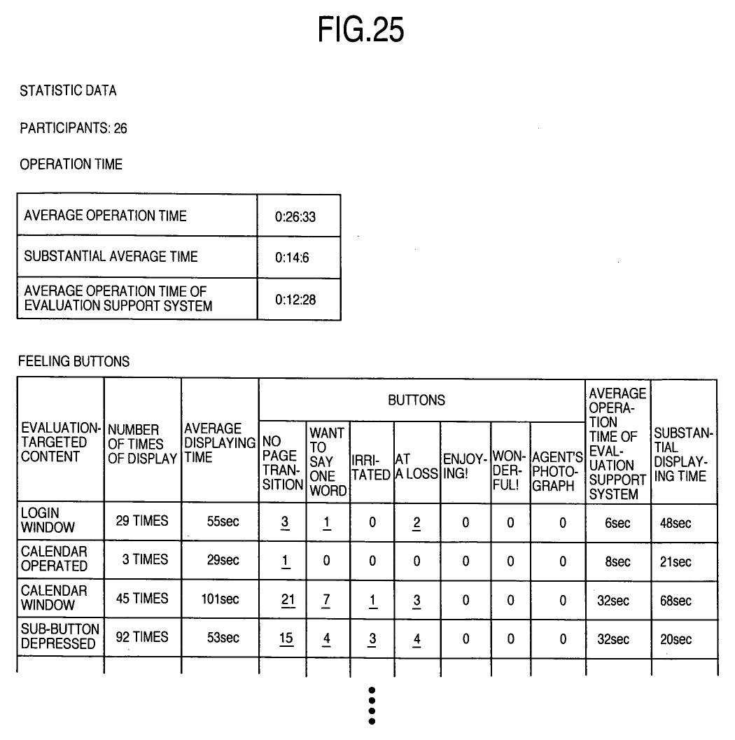

The evaluation contents are compiled and analyzed, if necessary, and as a result, a tabulated list window is produced that shows statistical data as shown in FIG. 25. This list window is displayed on the display 17. In this case, the evaluation-targeted content is assumed to include a login window, a calendar operation window, calendar window and a sub-button depression window. It is also assumed that twenty-six persons participate as evaluators in evaluating the evaluation-targeted contents. In addition, the list aggregates the number of times that each evaluation-targeted content was displayed, the average displaying time of each content, the average operating time of evaluation support system, the substantial displaying time (total sum), and the number of times that any one or ones of the feeling input buttons 36d˜36h were selected. The average operating time of evaluation support system is the time taken for the evaluator to operate (for example, the total time necessary for the evaluator to select and input in the questionnaire survey). The list further includes the average operating time of each participant, the substantial average time per participant as the average per participant of the total time in which this embodiment operated, and the average operating time of evaluation support system per participant.

The display information accumulated in the evaluation content management DB 14 can be changed in accordance with the evaluation-targeted content, but produced by using data input means 18 while it is being displayed.

While the feeling input buttons 36d˜36h are provided in order to enter the feelings of “IRRITATED”, “AT A LOSS”, “ENJOYING”, “WONDERFUL” and “WANT TO SAY ONE WORD” as evaluation results in this embodiment, other feelings can be inputted.

### Embodiment 2

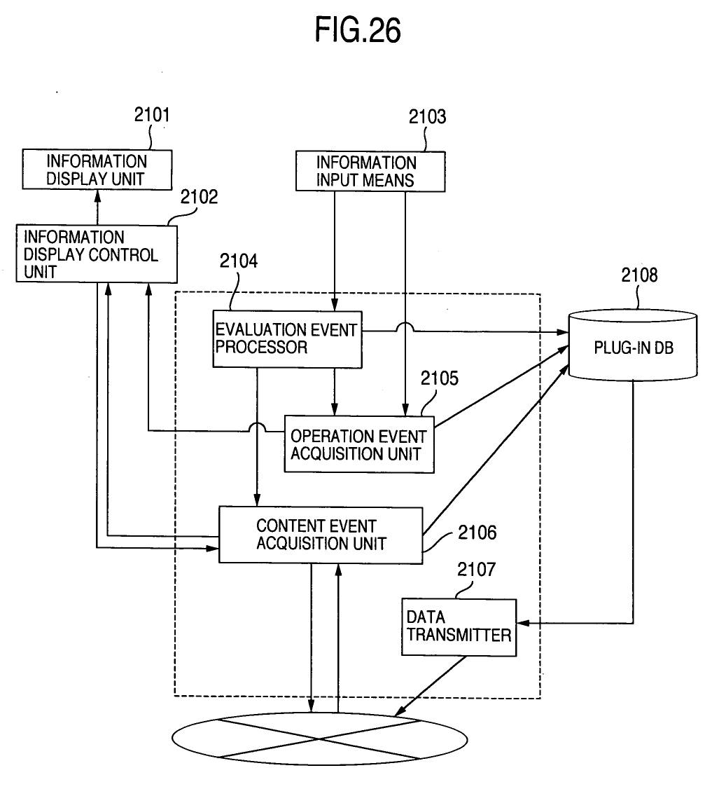

Another embodiment of the invention will be described in detail with reference to FIGS. 26 through 44. The present invention is not limited to this embodiment.

This invention relates to a usability evaluation support method and program. This invention has information input means and information output means, and can implement the evaluation of usability to the application and content that can be operated by an information processor connectable to network. The above information processor may be a computer system, cell phone system, personal digital assistance or network-connection type television. This invention is not limited to this kind of terminal, but may be applied to the information processor that is not connected to network, but has all necessary information held within itself, and that has information input means and information output means.

The embodiment 2 that will be mentioned below is a method of supporting the usability evaluation of the targeted content by using an incorporable program (hereinafter, referred to as plug-in program) in the information processor that has information input means and information display means and that can be connected to a network. This plug-in program has a function to intervene between the information input means and information display control means and to control information. That is, this program acquires the user's feedback about Web application or Web content of a page or particular location of displayed information. In addition, a method will be described that acquires a user's operation history and the content information from a server as an information source and causes the acquired information to correlate with content and time. Because of this correlation, the user's operation procedure and user's evaluation can be displayed in association with each other in the course of a sequence of operations, and thus the usability evaluation about the targeted content can be supported.

While this embodiment supports the usability evaluation about Web site, the present invention can implement the evaluation about application window and content other than the Web system that is run on a Client/Server system or Peer-to-Peer system.

FIG. 26 is a block diagram of an information processor in which an evaluation plug-in program is incorporated for the usability evaluation as in this embodiment.

The evaluation plug-in program in this embodiment is formed of an evaluation event processor 2104, an operation event acquisition unit 2105, a content event acquisition unit 2106, and a data transmitter 2107.

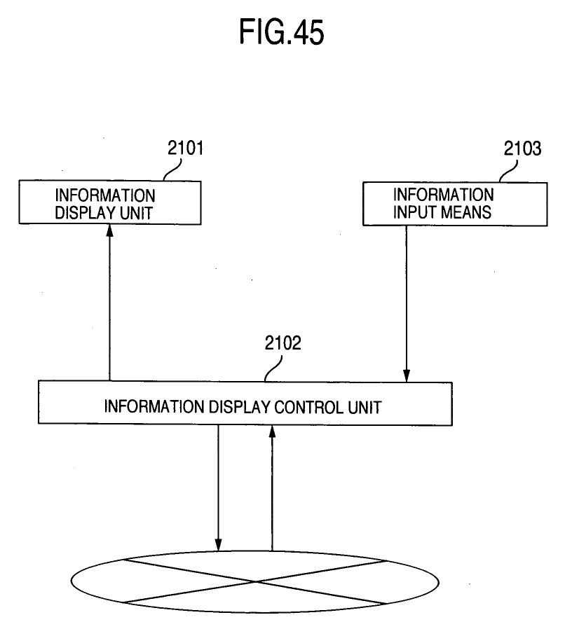

FIG. 45 is a block diagram of the conventional information processor. The evaluation plug-in program of this invention corresponds to the section surrounded by a broken line as indicated in FIG. 26.

The user browses information of application or content to be evaluated through an information display 2101, and handles information input means 2103 formed of a keyboard, mouse, touch panel, barcode reader or speech recognition device to enter evaluation information in response to questions about application and content.

The evaluation event processor 2104 receives the evaluating operations of the user's input information sent from the information input means 2103, acquires the evaluation operation history, and causes it to be recorded in a plug-in database (hereinafter, referred to as plug-in DB) 2108. The evaluation event processor 2104 also supplies start-to-acquire command and stop-to-acquire command to the operation event acquisition unit 2105 and content event acquisition unit 2106.

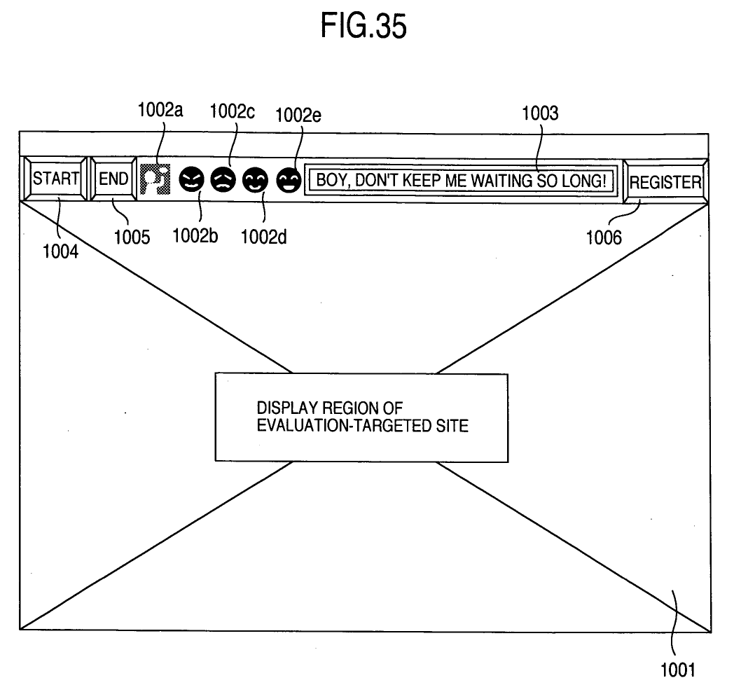

The evaluation operations are to operate evaluation buttons 1002a, 1002b, 1002c, 1002d, 1002e, 1004, 1005 and 1006, and write in an evaluation-input field 1003 as provided on the top of the window shown in FIG. 35.

The operation event acquisition unit 2105 receives other information than the evaluation operations of the user's input information sent from the information input means 2103, acquires the operation history, causes it to be recorded in the plug-in DB 2108, and then transmits the received input information to an information display control unit 2102.

In response to the acquisition start command from the evaluation event processor 2104, the content event acquisition unit 1206 receives information from the information display control unit to communicate with a server. Then, it acquires the history of communication with the server, and causes it to be recorded in the plug-in DB 2108.

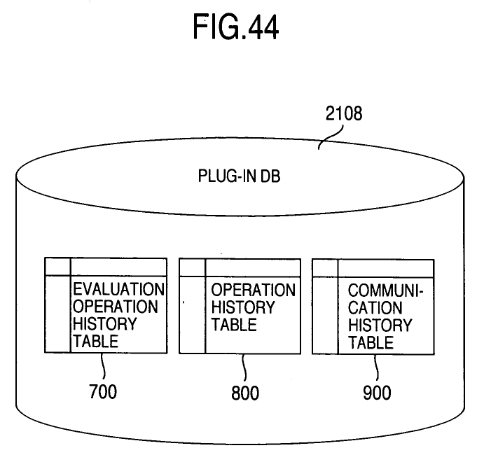

FIG. 44 shows an example of the construction of plug-in DB 2108. The plug-in DB 2108 has an evaluation operation history table 700, an operation history table 800, and a communication history table 900.

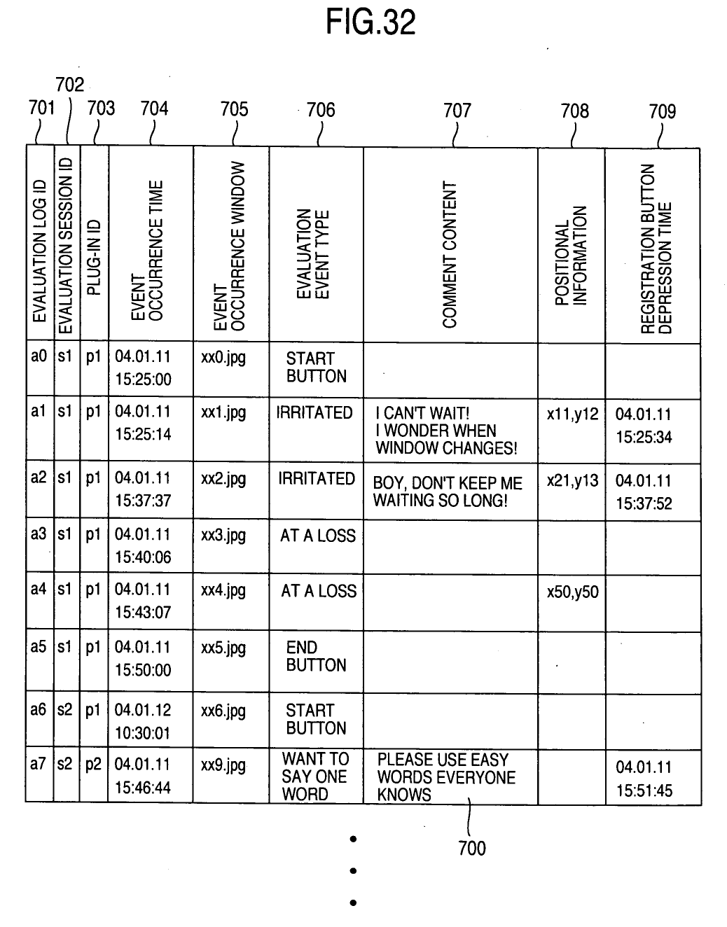

The evaluation operation history, operation history and communication history will be later described in detail with reference to FIGS. 32, 33 and 34, respectively.

The information display control unit 2102 receives the user's input information that is entered by the information input means 2103 and sent through the operation event acquisition unit 2105. The information display control unit 2102 then properly supplies the input information to the information display unit 2101 or content event acquisition unit 2106. In addition, the control unit 2102 receives and processes the content information from the server through the content event acquisition unit 2106, thus controlling the display information.

The plug-in DB 2108 records the evaluation operation history, operation history and communication history.

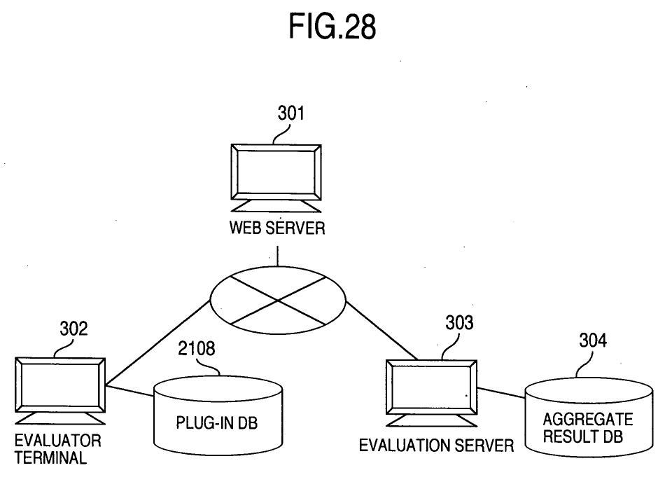

The data transmitter 2107 transmits the information recorded in the plug-in DB to an evaluation server 303 of FIG. 28 through the network.

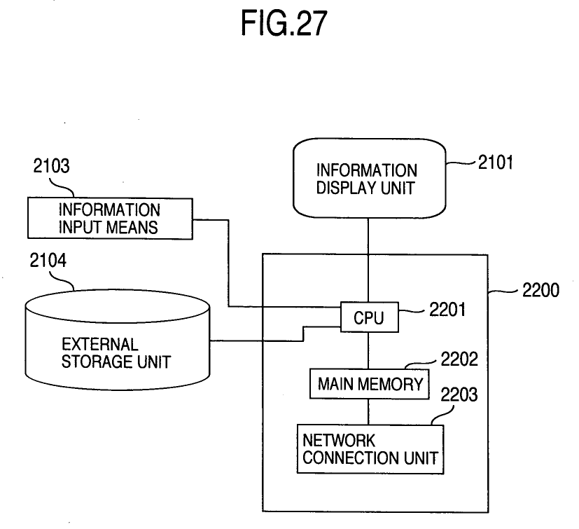

FIG. 27 shows hardware construction of the information processor that has information input means and information display means and is connectable to the network. This processor has information input means 2103, information display unit 2101, a CPU 2201, a main memory 2202, a network connection unit 2203 and an external storage unit 2204.

FIG. 28 shows the network structure for implementing the method of this embodiment. The network has a Web server 303 as a transmission source of the Web content to be targeted for usability evaluation, a user terminal 302, and the evaluation server 303. The user terminal 302 has the hardware construction shown in FIG. 27, and has the evaluation plug-in program mentioned with reference to FIG. 26. The evaluation server 303 receives data from the plug-in DB 2108 shown in FIG. 26, compiles the received data and causes the compiled result to be recorded in an aggregate result DB 304.

The Web server 301 and evaluation server 303 are information processors having the construction based on the hardware structure shown in FIG. 27.

FIG. 35 shows an example of the evaluation interface in which the user enters information about evaluation of Web application and Web content to be evaluated.

In the example shown in FIG. 35, buttons and an input form to operate and write down are displayed on the top of a region 1001 prepared for an evaluation-targeted site. The user can depress the evaluation start button 1004 to order to start evaluating, and depress the evaluation end button 1005 to order to finish the evaluation. In addition, there are shown the buttons 1002b, 1002c, 1002d and 1002e that express two pairs of plus and minus feelings. The user can select the button corresponding to his or her feeling to thereby send back as the evaluation about evaluation-targeted Web application or Web content. Moreover, in addition to these fed-back feelings, the user can write down the user's impression in the field 1003 while the user is operating the evaluation-targeted content, and depress the registration button 1006, thus sending the impression back as evaluation. In addition, the button 1002a is provided to allow the user to send comment regardless of feelings. This field 1003 can be enabled to write down by pressing any one of the buttons 1002a, 1002b, 1002c, 1002d and 1002e.

While the buttons are provided to express four different feelings as shown in FIG. 35, an arbitrary number of feelings may be applied to the evaluation. The functions for evaluation may be provided anywhere on browser, such as in the lower area, left area, or right area of the region 1001 prepared for the evaluation-targeted site.

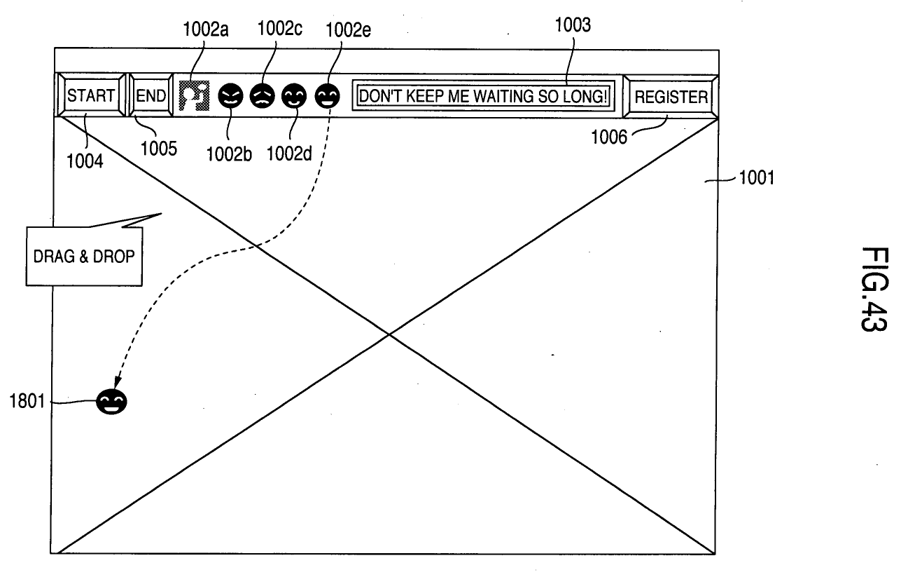

FIG. 43 shows an example of the evaluation interface on which the user can specify a location to evaluate within the displayed information.

As illustrated in FIG. 43, the user can move any one of the evaluation buttons 1002a, 1002b, 1002c, 1002d and 1002e displayed on the browser to the location where the evaluation is desired to feed back by drag & drop operation as indicated at 1104 on the browser, thus specifying the evaluation location. The way to specify the evaluation location may be executed by clicking a feeling button and then clicking the evaluation location.

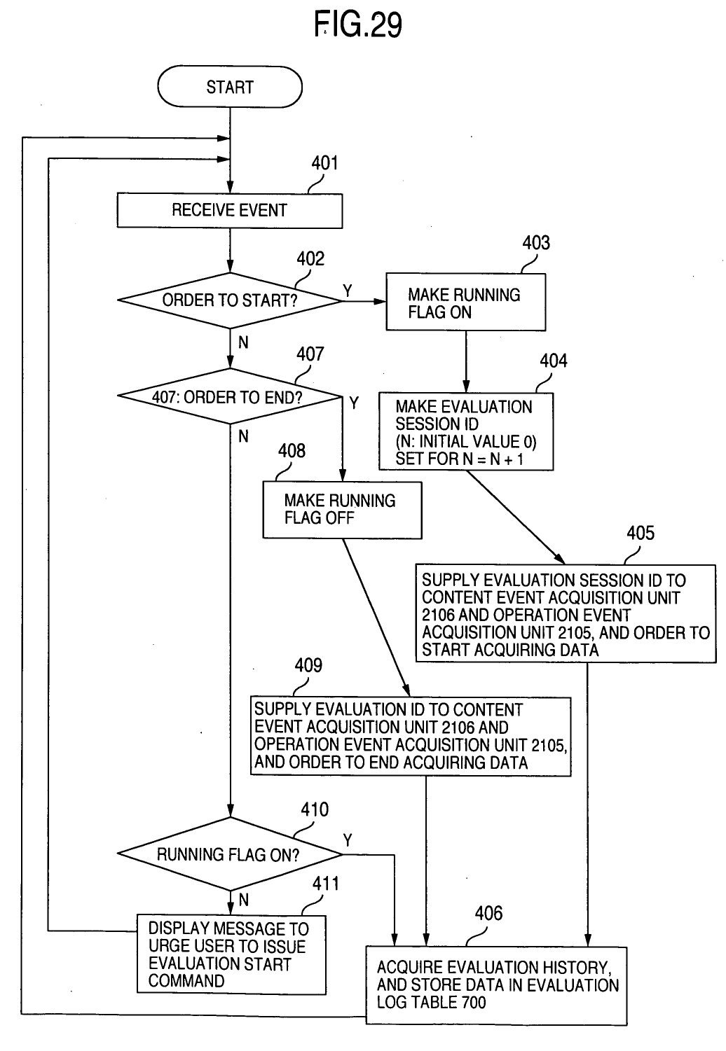

FIG. 29 is a flowchart of the algorithm that the evaluation event processor 2104 processes. First, the input information about evaluation is received as an event from the user through the information input means (step 401).

If the received event orders to start evaluation (step 402), evaluation-running flag is turned on (step 403), and evaluation session ID is incremented by 1 from initial value 0 (step 404). Then, the evaluation session ID is sent to the operation event acquisition unit 2105 and content event acquisition unit 2106, ordering to start acquiring data (step 405). Thereafter, the evaluation history of the received event is acquired and stored as data in the evaluation log table 700 (step 406), and then the program goes back to the event-reception waiting state.

FIG. 32 shows an example of the format of evaluation log table 700. The evaluation log table 700 is a table for recording the evaluation history information acquired at the evaluation event processor 2104. This table contains an evaluation log ID 701, an evaluation session ID 702, a plug-in ID 703, an event occurrence time 704, an event occurrence window image 705, an evaluation event type 706, a comment content 707, positional information 708, and a registration button depression time 709.

The evaluation log ID 701 is the ID for uniquely identifying history information. The evaluation event processor 2104 assigns it in step 406.

The evaluation session ID 702 is the ID that identifies the events occurring during the interval from when the evaluation start command is received from the user to when the evaluation end command is received. The evaluation event processor 104 assigns it in step 404.

The plug-in ID 703 is the ID for judging which evaluation plug-in program was used to acquire information. The ID is previously assigned to each of the plug-in programs in order to uniquely identify. All the evaluation event processor 2104, operation event acquisition unit 2105 and content event acquisition unit 2106 hold the same value for each plug-in program.

The event occurrence time 704 represents the time at which the evaluation event occurred, or the time at which the event is received in step 401.

The event occurrence window image 705 is recorded as the image at the time when the evaluation event occurred. This image is acquired in step 406.

The evaluation event type 706 is used to identify the operation about the user's evaluation. This event type is expressed by any selected one of the buttons, such as the buttons shown in FIG. 10, or the evaluation start button 1004, evaluation end button 1005, plus and minus feeling buttons 1002b, 1002c, 1002d, 1002e, and button 1002a for the feedback of comment as evaluation regardless of impression.

The comment content 707 is the content of the comment that the user wrote down in the comment input field 1003 shown in FIG. 35.

The positional information 708 is the coordinates of the location at which the user specified as the evaluation location by the method mentioned with reference to FIG. 43.

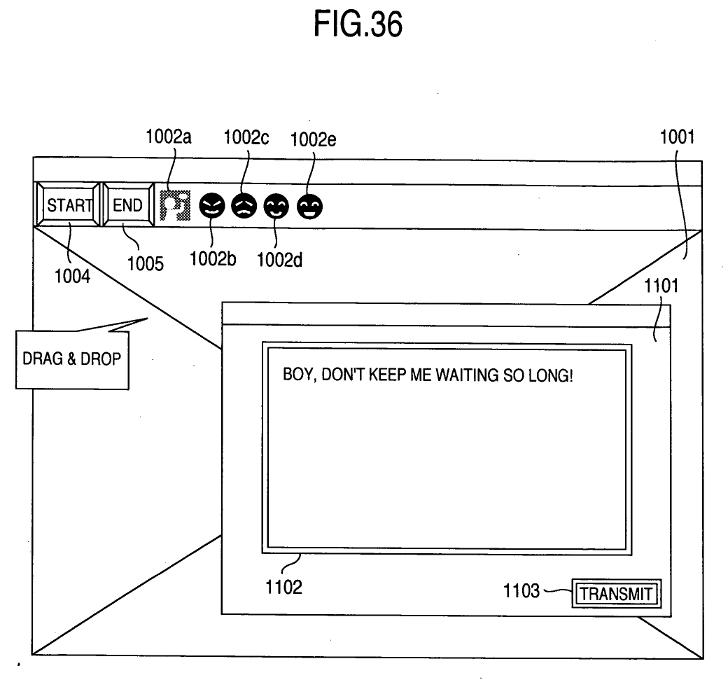

The registration button depression time indicates the time at which the user depressed the registration button 1006 shown in FIG. 35 or FIG. 43 and a transmission button 1103 shown in FIG. 36.

If the received event does not order to start the evaluation (step 402) and does not order to finish the evaluation (step 407), judgment is made of whether the evaluation-running flag is turned on (step 410). If the flag is turned on, the evaluation history of the received event is acquired, and the data is recorded in the evaluation log table 700 (step 406). Then, the program goes back to the event reception waiting state. If the flag is not turned on in step 410, a message is displayed ordering the user to issue the evaluation start command (step 411). Then, the program goes back to the event reception waiting state.

If the received event orders to finish the evaluation (step 407), the evaluation-running flag is turned off (step 408). Then, the operation event acquisition-unit 2105 and content event acquisition unit 2106 is ordered to finish the acquisition of data (step 409). Subsequently, the received event evaluation history is acquired, and the data is recorded in the evaluation log table 700 (step 406). Then, the program goes back to the reception waiting state.

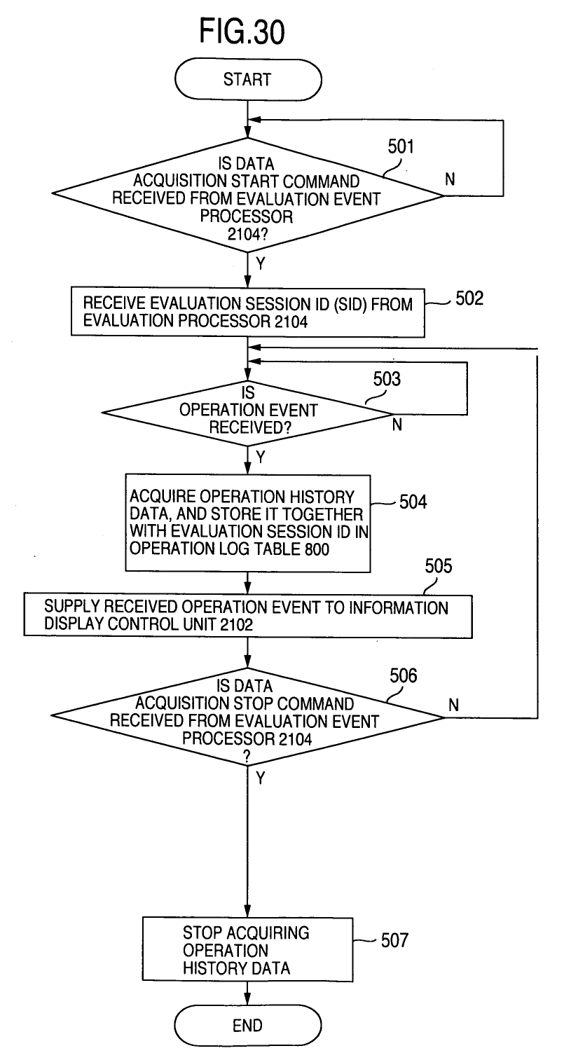

The algorithm in the operation event acquisition unit 2106 will be described with reference to FIG. 30. If a data-acquisition start order is received from the evaluation event processor 2104 (step 501), the evaluation session ID is received from the evaluation event processor 2104 (step 502). If the operation event is received (step 503), the operation history data of the received event is acquired, and the operation history data is recorded in the operation log table 800 together with the evaluation session ID (step 504). Then, the received operation event is sent to the information display control unit 2102 (step 505). The above steps 503, 504 and 505 are repeated until the data-acquisition stop order is received from the evaluation event processor 2104 (step 506). If the data-acquisition stop order is received from the evaluation event processor 2104 (step 506), the operation history data is stopped from being acquired (step 507).

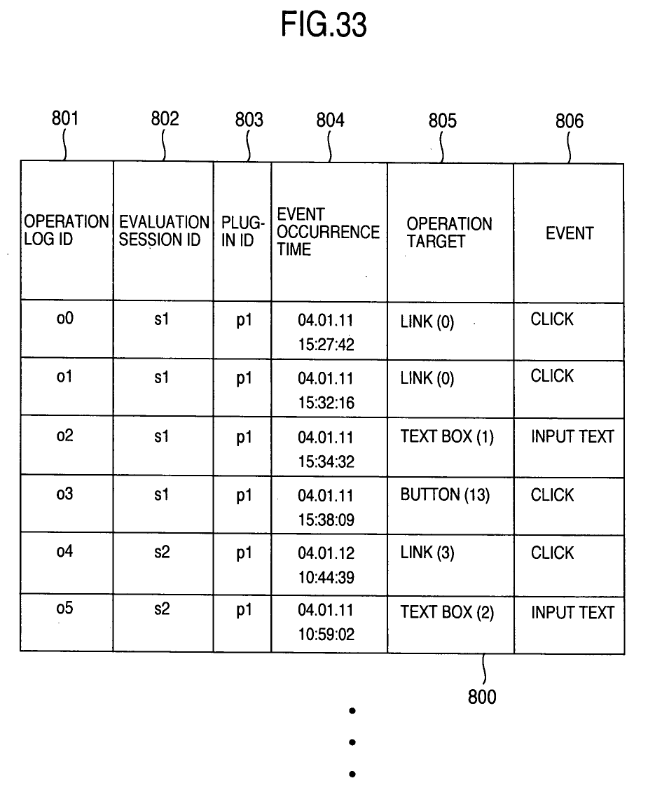

FIG. 33 shows an example of the format of the operation log table 800. The operation log table 800 is a table for recording the operation history information obtained by the operation event acquisition unit 2106. This table contains an operation log ID 801, an evaluation session ID 802, a plug-in ID 803, an event occurrence time 804, an operation target 805, and an event 806.

The operation log ID 801 is the ID for uniquely identifying the operation history information. The operation event acquisition unit 2106 assigns it in step 504.

The evaluation session ID 802 is the ID to identify the events occurring from when the evaluation start order is received from the user to when the evaluation end order is received. The evaluation event processor 2104 assigns it in step 502.

The plug-in ID 803 is the ID to judge which evaluation plug-in program is used to obtain information. It is held in each of the evaluation event processor 2104, operation event acquisition unit 2105, and content event acquisition unit 2106.

The event occurrence time 804 is the time at which the event occurred, or at which the event was received in step 503.

The operation target 805 is received from the information input means in order to identify the target of the operation event such as clicking or inputting.

The event 806 is received from the information input means in order to identify the user's operation such as clicking or inputting.

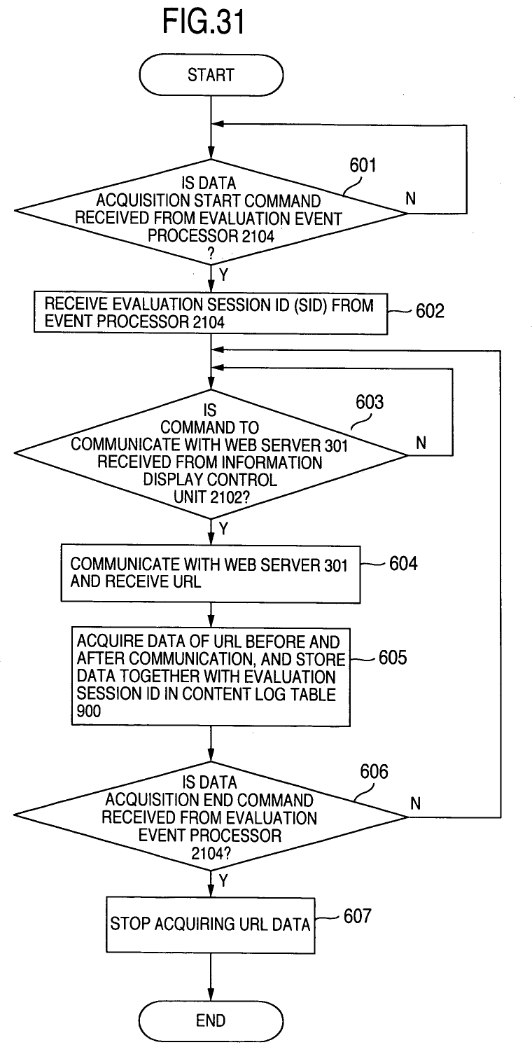

The algorithm used in the content event acquisition unit 2107 will be described with reference to FIG. 31. When the order to start acquiring data is received from the evaluation event processor 2104 (step 601), the evaluation session ID is received from the evaluation event processor 2104 (step 602). When the order to communicate with the Web server 301 is received from the information display control unit 2102 (step 603), the communication with the Web server 301 is made to receive URL (step 604). The data of URL before and after communication is acquired, and recorded together with the evaluation session ID in the content log table 900 (step 605). The steps 603, 604 and 605 are repeated until the order to stop acquiring data arrives from the evaluation event processor 2104 (step 606). When the order to stop acquiring data is received from the evaluation event processor 2104 (step 606), the URL data is stopped from being acquired (step 607).

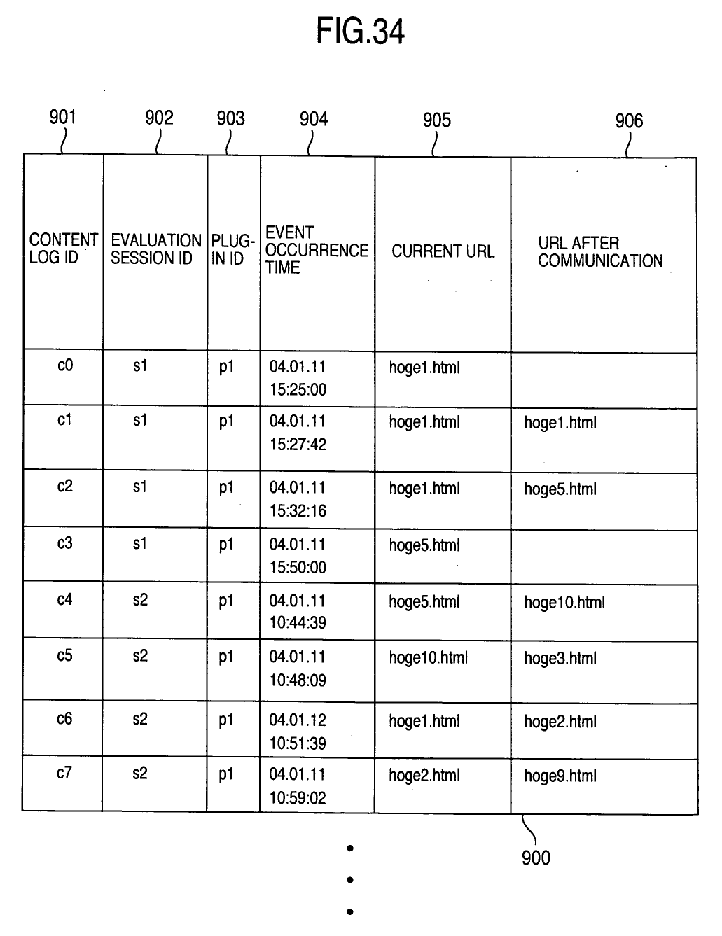

FIG. 34 shows an example of the format of the content log table 900. The content log table 900 is the table to record the URL information acquired by the content event acquisition unit 2107. This table contains a content log ID 901, an evaluation session ID 902, a plug-in ID 903, an event occurrence time 904, a current URL 905, and a post-communication URL 906.

The content log ID 901 is the ID to uniquely identify the content log information. The content log acquisition unit 2107 assigns it.

The evaluation session ID 902 is the ID to identify the events occurring from when the order to start evaluating is received from the user to when the order to stop evaluating is received. The evaluation event processor 2104 assigns it in step 5602.

The plug-in ID 903 is the ID to judge which evaluation plug-in program is used to acquire information. It is held in each of the evaluation event processor 2104, operation event acquisition unit 2105 and content event acquisition unit 2106.

The event occurrence time 904 indicates the time at which communication is made with the server in step 604.

The current URL 905 indicates the URL at the time when the order to communicate with the Web server 301 is received from the information display control unit 2102.

The URL 906 after communication is the new URL just received from the Web server 301.

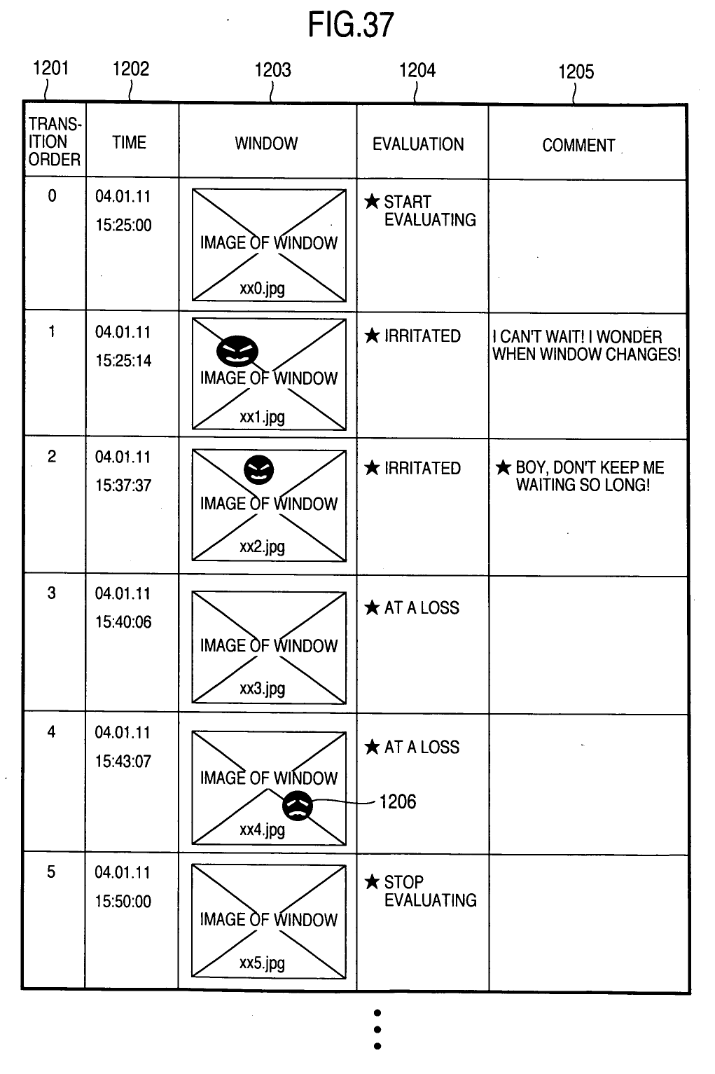

The information acquired as above is used to display the evaluation results shown in FIG. 37. FIG. 37 shows an example of the evaluation results that can be produced from the information of evaluation log table 700. The table shown in FIG. 37 lists a user's evaluation time 1202, an image 1203 displayed at the evaluation time, a user's evaluation 1205, and a user's comment 1205 in the order of event occurrence time 702, or in the order of user's operation. Here, when the value of the positional information 708 of evaluation log table 700 is not null, an evaluation mark 1206 is displayed overlapped on the image 1263 at the corresponding position, thus making the evaluation result easy to understand intuitively.

The user's evaluation time 1202 is the information obtained from the event occurrence time 704 of evaluation log table 700. The image 1203 is the information acquired from the event occurrence image 705 of evaluation log table 700. The user's evaluation 1205 is the information obtained from the evaluation event type 706 of evaluation log table 700. The user's comment 1205 is the information acquired from the comment content 708 of evaluation log table 700.

The data transmitter 2107 transmits the stored evaluation operation history table 700, operation history table 800 and communication history table 900 from the plug-in DB 2108 to the aggregation server 303.

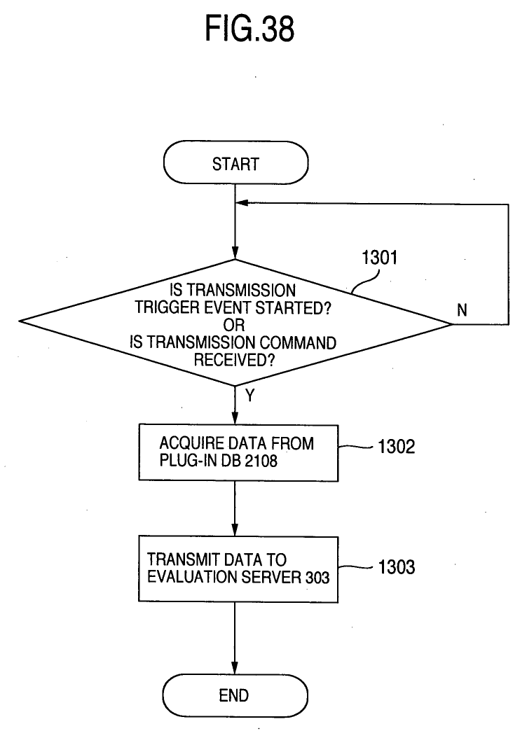

FIG. 38 shows the algorithm used in the data transmitter 2107.

If a transmission trigger event previously set is started (step 1301), data is acquired from the plug-in DB 304 (step 1302), and data is transmitted to the evaluation server 303 (step 1303). Then, the algorithm ends.

The transmission trigger event previously set in the data transmitter is the threshold of the amount of data stored in the plug-in DB 2108 or the set time such as ten o'clock on Monday stored therein. The transmission trigger previously set can be replaced by the transmit order received from the user.

The aggregation server 303 compiles the data received from the data transmitter 2108 to produce an aggregate result table having the items of the sum of sets corresponding to the total items contained in the evaluation log table 700, operation log table 800 and content log table 900.

Each row is acquired from the evaluation log table 700, and written as one row of the aggregate result table. This operation is repeated until the data of the evaluation log table is completely processed. At this time, if the corresponding item has no information, its field is left vacant, and only the other fields have information.

The data in each of the operation log table 800 and content log table 900 is similarly processed to form the aggregate result table.

When all data is completely acquired, it is sorted with the plug-in ID used as the first key, the evaluation session ID as the second key and the event occurrence time as the third key.

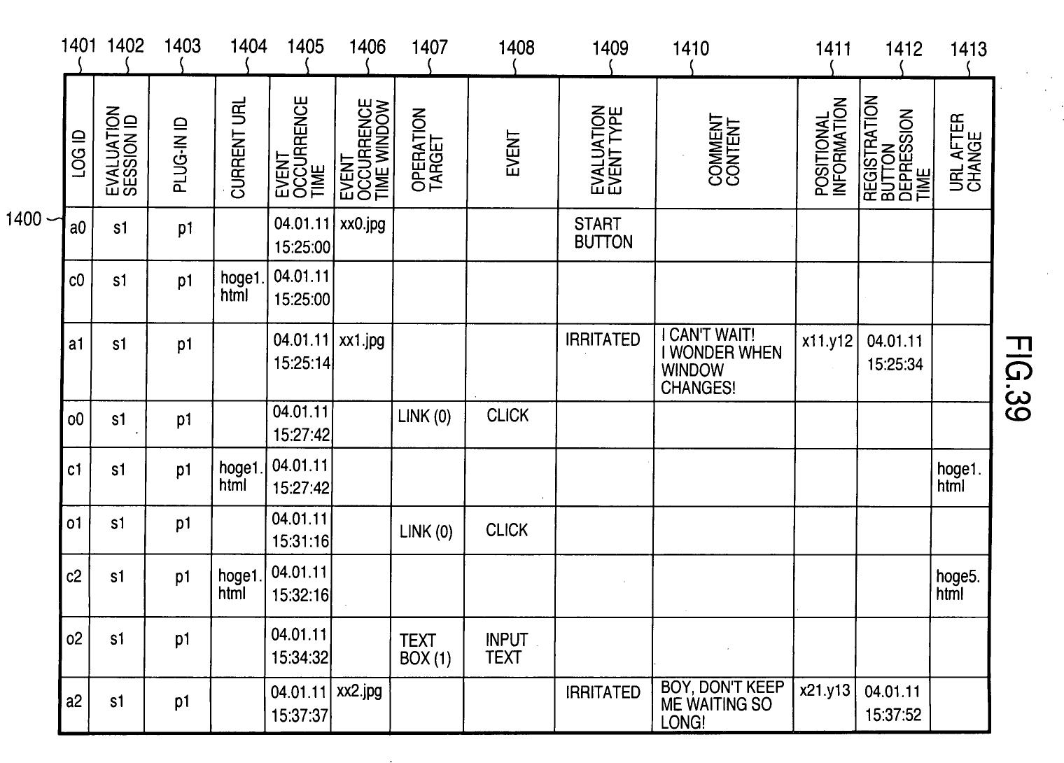

FIG. 39 shows an example of the aggregate result table. The aggregate result table 1400 has columns of log ID 1401, evaluation session ID 1402, plug-in ID 1403, current URL 1404, event occurrence time 1405, event occurrence time image 1406, operation target 1407, event 1408, evaluation event type 1409, comment content 1410, positional information 1411, registration button depression 1412, and updated URL 1413.

The log ID 1401 is the item corresponding to the evaluation log ID 701 in the evaluation history table 700, to the operation log ID 801 in the operation history table 800 and to the content log ID 901 in the communication history table 900.

The evaluation session ID 1402 is the item corresponding to the evaluation session ID 702 in the evaluation history table 700, to the evaluation session DI 802 in the operation history table 800, and to the evaluation session ID 902 in the communication history table 900.

The plug-in ID 1403 is the item corresponding to the plug-in ID 703 in the evaluation history table 700, to the plug-in ID 803 in the operation history table 800, to the plug-in ID 903 in the communication history table 900.

The current URL 1404 is the item corresponding to the current URL 905 of the communication history table 900.

The event occurrence time 1405 is the item corresponding to the event occurrence time 704 in the evaluation history table 700, to the event occurrence time 804 in the operation history table 800, and to the event occurrence time 904 in the communication history table 900.

The event occurrence time image 1406 is the item corresponding to the event occurrence time image 705 of the evaluation history table 700. The operation target 1407 is the item corresponding to the operation target 805 of the operation history table 800. The event 1408 is the item corresponding to the operation target 806 of the operation history table 800. The evaluation event type 1409 is the item corresponding to the evaluation event type 706 of the evaluation history table 700. The comment content 1410 is the item corresponding to the comment content 707 of the evaluation history table 700. The positional information 1411 is the item corresponding to the positional information 708 of the evaluation history table 700. The registration button depression time 1412 is the item corresponding to the registration button depression time 709 of the evaluation history table 700. The updated URL 1413 is the item corresponding to the updated URL 906 of the communication history table 900.

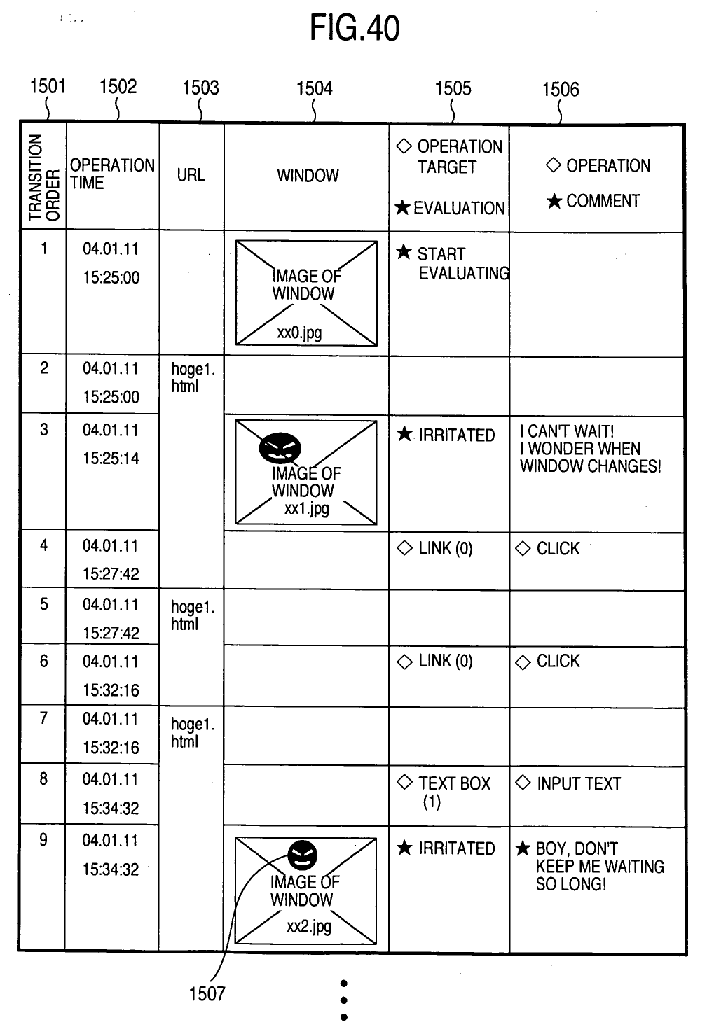

FIG. 40 shows an example of the evaluation result displayed by using the aggregate result table 1400.

As illustrated in FIG. 40, the sequence of operations from the evaluation start order to evaluation stop order from the user is displayed as a group of evaluation results. The results are displayed as to the log having the same evaluation session ID.

This table has columns of a succession order 1501, an operation time 1502, a URL 1503 at the operation time, a window image 1504 at the operation time, a user's operation target or evaluation 1505, and a user's operation or comment content 1506 in the order of event occurrence time 1405, or in the order of user's operation.

The operation time 1502 is acquired from the event occurrence time 1405.

The URL is obtained from the current URL 1404. It can be considered that the rows between a row, for example, log ID=c0, having a value in the column of current URL 1404 and another row, for example, log ID=c1 having a value in the column are associated with the content of the URL of the row of log ID=c0 as shown in FIG. 29.

The image 1504 at the operation time is obtained from the event occurrence time window image 1406. At this time, when the value of positional information 1411 is not null, a mark 1507 of evaluation is displayed overlapped on the image 1504 at the corresponding position, making the evaluation result easy to intuitively understand.

The user's operation target or evaluation 1505 is acquired from the operation target 1407 or evaluation event type 1409. The user's operation or comment content 1506 is the information obtained from the event 1408 or comment content 1410.

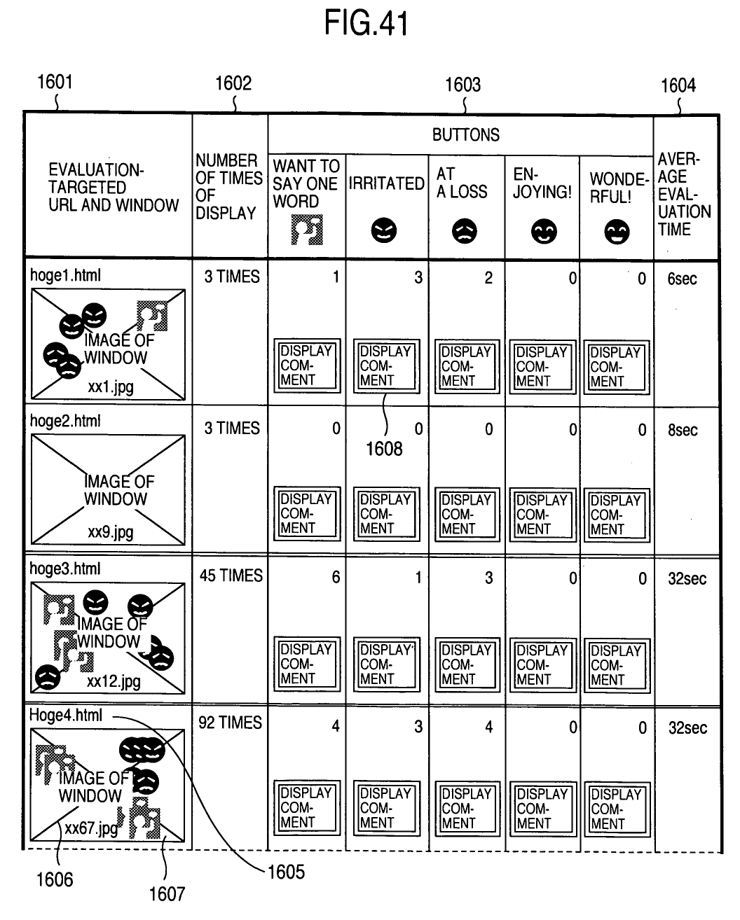

FIG. 41 shows an example of the window indicating the table of the user's evaluation for each URL. The window shown in FIG. 41 is displayed based on the information of aggregate result table 1400.

This table contains columns of an evaluation targeted URL and page window 1601, the number of times of indication 1602 for each URL in the column 1601, the number of times of button depression 1603 for evaluation of the content of each URL 1601, and an average user's evaluation time 1604.

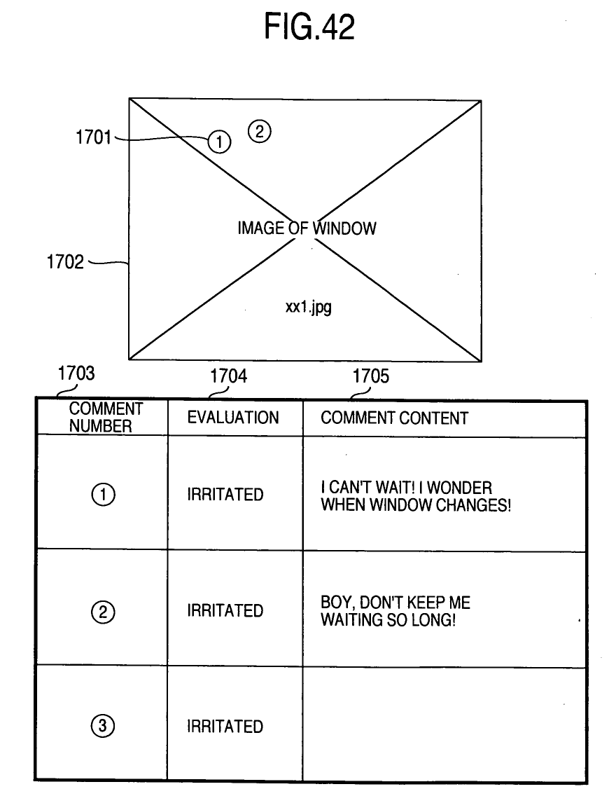

If the operator depresses a comment display button 1608 on the table window of FIG. 41, a list of the user's comment about the image of the corresponding URL is displayed. FIG. 42 shows an example of the list.

The example shown in FIG. 42 shows a list of user's comment of the evaluation made as “IRRITATED” about the page window of the URL expressed by hogel.html as shown in FIG. 41. The window image 1702 is a selected one of the event occurrence window pages 1406 of the URL expressed by hogel.html in the aggregate result DB 1400. This example is the first one found on the column of event occurrence time window image 1406 when the images are searched from the top row. Thus, it may be any image as long as the URL is expressed by hogel.html.

The number 1701 indicated on the image corresponds to the comment number 1703. When the user writes down the corresponding comment that also specifies the location on the image, or when the coordinates are recorded on the positional information 1411 of the aggregate result DB 1400 shown in FIG. 39, this position on the column 1411 corresponds to the position number indicated on the image.

Under the picture 1702 is displayed the list of user's comment of the evaluation made as “IRRITATED” about the page window of the URL expressed by hogel.html. The evaluation 1704 indicates the kind of button that the user depressed, and the comment content 1705 shows the comment that the user wrote down. The evaluation 1704 is obtained from the evaluation event type 1409 of the aggregation result DB 1400 and the comment content 1705 from the comment content 1410 of the aggregation result DB.

In this embodiment, it is supposed that the evaluation plug-in program is downloaded from the evaluation server 303 shown in FIG. 28. When the plug-in program is downloaded, the server assigns the plug-in ID to the program in order to uniquely distinguish from another one.

The plug-in program may be downloaded from a particular Web site other than the evaluation server, and installed by storing it in a recording medium and reading out from the medium.

While the evaluation-targeted URL is displayed as an evaluation-targeted page in this embodiment, a method of naming images can be used. In this case, this can be implemented by separately providing a table of URL and image name.

While a compiling function exists on the aggregation server in this embodiment, the compiling function may be provided on any server such as the Web server 301, evaluation server 303, and user terminal 302. Similarly, the aggregate result DB 304 may be provided at any place. In addition, the user terminal 302 and Web server 301 may be incorporated in the same computer, and the user terminal 302 and evaluation server 303 may be incorporated in the same computer. Similarly, the Web server 301 and evaluation server 303 may be provided in the same computer. The user terminal 302, Web server 301 and evaluation server 303 may all be built in the same computer.

FIG. 36 shows an example of free input field 1003 shown in FIG. 35 that is displayed within another window 1101. If the user pushes any one of the buttons 1002a, 1002b, 1002c, 1002d and 1002e for evaluation on the window shown in FIG. 36, another window 1101 pops up, and the free input field 1102 is displayed on the window. If the user writes down the evaluation in the input field 1102 and then presses the transmission button 1103, the original main window 1001 is brought back to fully appear. The pop-up window shown in FIG. 36 is processed to display by the evaluation event processor 2104 as shown in FIG. 29. In the flowchart of FIG. 29, in steps 410˜406, judgment is made of whether the user depressed any one of the buttons 1002a, 1002b, 1002c, 1002d and 1002e. If any one of the buttons 1002a, 1002b, 1002c, 1002d and 1002e is depressed, the pop-up window 1101 is displayed. After the transmission button 1103 is received, the process goes to step 406.

While variously deformed buttons are used to select user's feelings for simple evaluation as in FIGS. 36, 37 and 44, numerical 5-stage evaluation using five evaluation values from bad to good impressions or availability effect matched to the characteristics of Web application or Web content can be used.

Thus, the system of the embodiment 2 is provided between the evaluator terminal and the information controller to receive an event, and judge whether the event is an evaluation event. If it is an evaluation event, the system acquires the event-related information and the information fed back from the evaluator and makes the information be stored in the DB. Thus, the system according to this embodiment can acquire the user's operations and user's comments about the evaluation-targeted system that involves the succession of a plurality of user/interface window pages.

### INDUSTRIAL APPLICABILITY

This invention can be applied to the usability evaluation support method and system for supporting the user when the user evaluates a Web site about whether it is easy to use.

1. A usability evaluation support method of displaying evaluation-targeted content of evaluation-targeted sites on an evaluator terminal and requesting an evaluator to evaluate, said method being characterized by the steps:
displaying a survey window on said evaluator terminal wherein the survey window contains a plurality of feeling input buttons and said evaluation-targeted content so that said evaluator can selectively operate said feeling input buttons during the evaluation of said evaluation-targeted content and that said evaluator can enter information of said evaluator's emotion at arbitrary timings during the evaluation of said evaluation-targeted content.

2. A method according to claim 1, wherein when the evaluator selects and operates any one of said feeling input buttons, a feeling input window corresponding to the selected feeling input button is displayed on which the evaluator can input the details of the evaluator's feeling about said evaluation-targeted content as detailed information.

3. A method according to claim 2, said method comprising the steps of:
displaying an agent selection dialog box on the evaluator terminal before the evaluation of said evaluation-targeted content so that said evaluator can select any of the photographs of said displayed agents; and
displaying the photograph of the selected agent on said survey window and on said feeling input window so that said selected agent can guide said evaluator to operate on said survey window and on said feeling input window.

4. A method according to claim 3, wherein said agent's photographs can be made to serve as help buttons on said survey window and on said feeling input window.

5. A usability evaluation support system that causes evaluation-targeted content of an evaluation-targeted site to be displayed on an evaluator terminal and that causes an evaluator to evaluate said content, said system comprising:
said evaluator terminal;
a Web server of said evaluation-targeted site that provides said evaluation-targeted content; and
a proxy server for adding operation information to said evaluation-targeted content provided from said Web server of said evaluation-targeted site and supplying the information to said evaluator terminal, whereby
said evaluator terminal has displayed thereon a survey window of said evaluation-targeted content and a plurality of feeling input buttons as said operation information so that said evaluator can selectively operate said feeling input buttons to evaluate said evaluation-targeted content, and
said proxy server has means for storing the evaluation result sent from said evaluator terminal.

6. A usability evaluation support method that orders an evaluator terminal to display evaluation-targeted content and requests an evaluator to evaluate said content, wherein
said evaluator terminal has a control unit, an information input unit, an information display unit, a network connection unit and a plug-in DB, and
said control unit receives an event from said information input unit, judges whether said event is an evaluation event, controls said plug-in DB to store said event as an evaluation operation history if it is so or as an operation history if it is not, stores a log of a communication history between said terminal and said server connected via a network with the network connection to said plug-in DB and transmits the recorded information in said plug-in DB to said evaluation-targeted server connected to said plug-in DB via a network.

7. A method according to claim 1, wherein said feeling input buttons can be displayed to be movable to an arbitrary position on said evaluation-targeted content.
